(19) United States
(12) Patent Application Publication
(10) Pub. No.: US 2026/0237208 A1
(43) Pub. Date: Aug. 13, 2026

(54) VIDEO LABELLING OF SURGICAL VIDEO

(71) Applicant: Proximie Limited, Boston, MA (US)

(72) Inventors: Yang Liu, London (GB); Sebastien Ourselin, London (GB); Alejandro Granados Martinez, London (GB)

(21) Appl. No.: 19/152,955

(22) PCT Filed: Jan. 24, 2024
(86) PCT No.: PCT/GB2024/050193

§ 371 Date: Aug. 1, 2025

(30) Foreign Application Priority Data
Feb. 3, 2023 (GB) 2301543.1
Jul. 6, 2023 (GB) 2310400.3

(51) Int. Cl. G06V 20/40; G06V 10/62; G06V 10/74; G06V 10/764; G06V 10/776; G06V 10/82

(52) U.S. Cl. CPC G06V 20/46; G06V 10/62; G06V 10/74; G06V 10/764; G06V 10/776; G06V 10/82; G06V 20/41; G06V 2201/034

(57) ABSTRACT

The present disclosure relates to new surgical phase recognition methods named LoViT and SKIT. LoViT adopts video-clip level supervision to train a rich spatial feature extractor and then uses the Multi-scale temporal feature aggregator to combine local fine-grained and global macroscopic information to recognise surgical phases. Specifically, the Transformer-based LoViT allows detection and labelling of surgical phases in long video feeds with less loss of information than other existing methods. SKiT adopts video-clip level supervision to train a rich spatial feature extractor and then uses a Key-recorder to extract global macroscopic information indicative to key frames of surgical phase transition. Local fine-grained information and global macroscopic key features are fused using a fusion head. Moreover, our LoViT and SKiT systems utilise a Gaussian Kemal heatmap to learn phase transitions, which is significant to predict and grab the relationship between phases.

### TECHNICAL FIELD

The present disclosure generally relates to a method and system for processing machine learning models and associated training of said machine learning models. More particularly, in some embodiments the disclosure relates to the detection and labelling of surgical phases and phase transition within video of surgical procedures, referred to herein as surgical video, whether that be live or offline surgical video

The present disclosure can be applied to surgical video to automatically detect, extract and label surgical phase transitions to allow for better analysis of surgery performance, reduced difficulty of labelling, improved surgeon training video libraries etc.

### BACKGROUND AND RELATED ART

Surgical phase and action recognition are critical steps for understanding surgical workflows, quantifying surgeons' performance, and providing assistance that is reactive to the surgical context. While “phases” capture the general stages of surgery, “actions” describe the fine-grained steps in the form of tool-tissue interaction during surgery; it follows that in surgical planning a surgical phase can comprise several different (i.e. one or more) time sequenced surgical actions. Surgical phase and action recognition can be done offline (retrospectively after surgery) and online (in real-time during surgery). Online real time recognition requires recognizing stages and actions without future information, which helps alert and reduce surgeons' actions that are likely to result in complications.

Surgical Data Science (SDS) or Surgical Artificial Intelligence (SAI) aims to improve the quality of interventional healthcare through the capture, modelling, and analysis of patient data from medical devices within the operating room (OR). Surgical phase and action recognition are crucial steps toward understanding surgical workflows, quantifying surgeons' performance, and providing assistance that is reactive to the surgical context. During endoscopic-based interventions, surgical phase and action recognition aim to classify every video frame into holistic high-level stages of surgery, or into granular and fine tasks entirely from data, respectively. Furthermore, online recognition allows recognizing current activity without future information, which helps alert surgeons when approaching possible complications and support decision making to reduce their operative mistakes. Consequently, in contrast to action recognition, surgical phase recognition requires approaches that process videos over long time frames since each phase typically contains several actions.

Early work in surgical phase recognition proposed reference models for workflow recovery using Dynamic Time Warping and temporal registration, graphical probabilistic models for workflow mining using Hidden Markov Models, rule-based interpretation models for context-awareness using ontologies, and machine learning models for phase recognition using Support Vector Machines and Random Forests. These approaches extract features such as pixel intensity gradients and histograms or apply image pre-processing steps to extract visual cues based on colour, shape, and texture. Despite these techniques can be applied to different types of surgical interventions, the use of hand-crafted features is specific to surgery type and lead to design that is not fully generalisable.

Methodology for surgical phase recognition was transformed by the advent of deep learning allowing for more sophisticated spatio-temporal feature extraction mechanisms. Spatial feature embedding can be extracted from video frame-class pairs in a fully supervised fashion using (hierarchical) Convolutional Neural Networks (CNNs). However, similar frames can be observed across different phases, as exemplified in FIG. 1, causing ambiguity and thus over-fitting. Temporal feature extraction can be abstracted by searching for relationships between contiguous frames using Recurrent Neural Networks (RNNs), such as the long short-term memory gates (LSTM). However, RNNs struggle with modelling long-range temporal dependencies because of their sequential (non-parallel) nature. Then CNN-based models are proposed for temporal feature extraction, but they require a high number of processing and memory resources for long videos or should drop lots of temporal context information. For instance, the current state-of-the-art in surgical phase recognition is Trans-SVNet, which processes temporally long video using a Temporal Convolution Network (TCN) to aggregate temporal features, where the dilated convolution mechanism of TCN causes some fine-grained and coherent information to be lost. Despite this, transformer-based architectures have recently and successfully been introduced for vision tasks, although computing power and memory consumption problems still exist.

A common problem in surgical phase and action recognition is that individual video frames of a surgical scene, which are the atomic image components of videos, frequently appear similar at different phases/actions of the surgical procedure, causing a degree of ambiguity that makes it difficult to independently distinguish and recognize the particular surgical action and phase. Therefore, innovative surgical phase recognition models are required that rely on more effective spatial and temporal feature extraction mechanisms.

### SUMMARY OF THE INVENTION

In view of the above noted problems of the prior art, motivated by designing deep learning algorithms that can efficiently interpret surgical phases of long surgical videos without impacting performance, we disclose herein a surgical video processing concept that we refer to herein as “LoVIT”—a Long Video Transformer—that outperforms state-of-the-art work as well as a second surgical video processing concept referred to herein as “SkiT”. The specific contributions of this work include:
a temporally-rich spatial feature extractor based on an anticipation video transformer (AVT) model using a video transformer (ViT) for video clip supervision,
multiscale temporal feature aggregation of local information using vanilla self-attention, and global relationships following ProbSparse self-attention [1],
an efficient multiscale temporal feature aggregation of local information combined with a global key information extractor based on key polling, and
a Gaussian kernel heatmap for highlighting critical temporal information of phase transitions.

The present disclosure therefore embodies a rich spatial feature extractor and a multi-scale temporal feature aggregator. Multi-scale temporal feature aggregation utilizes two local transformer-based models: Ls (small)-Trans and Ll (large)-Trans, for abstracting short fine-grained information, such as actions and tools, and a global transformer-based Informer model: G Informer for processing long-term information, including key clip information of current phase and the relationship among phases. An efficient multiscale temporal feature aggregation adopting a small local Transformer Ls (small)-Trans for abstracting short fine-grained information, such as action and tools, but now combined with a global key information extractor (Key-Recorder) for keeping track of global key events appearing throughout time. A multi-scale temporal fusion model integrates both local and global information that is used for classifying surgical phases together with the support of heatmap-guided supervision.

The present disclosure for surgical phase recognition will be described against state-of-the-art methods and consists of three main contributions. Our Long Video Transformer (LoViT) framework, shown in FIG. 2, embodies 1) a rich spatial feature extractor, 2) a multi-scale temporal feature aggregator, and 3) a phase-level heatmap guided supervision.

First, existing approaches use spatial feature extractors that are trained by frame-level supervision, i.e. given a single video frame (image) they classify surgical phases. Instead, we propose a new method to train a temporally-rich spatial feature extractor, which is shown in FIG. 3. Specifically, we use spatial feature extractor S to extract the current and past frames into an embedding sequence F, which are used as inputs to an extra temporal aggregator T to classify surgical phases. Considering the limitations of computing resources and assuming the key temporal information generally appears at the beginning of every phase, we only select a small number of frames as input sequence, where frames are considered from the start of the current phase up to the current frame at an equal interval. Note that we drop out the temporal aggregator T after training the spatial feature extractor S. Our work indicates that a temporally-rich spatial feature extractor is essential for supporting an accurate recognition network.

Second, compared with known methods with TCN structure for grabbing long-term temporality, our method LoViT adopts a multi-scale temporal feature aggregator. Specifically, our feature aggregator contains two cascaded L-Transformers, which are shown in FIG. 6, with vanilla self-attention to aggregate local (short) temporal features, and a Global Temporal Informer (G-Informer), which is shown in FIG. 5, based on Informer with a ProbSparse self-attention mechanism to efficiently capture long-range dependencies. Moreover, we adopt a transformer-based multi-scale fusion module MF-Trans to fuse local and global features together that result from the L-Trans and G-Informers.

Last, surgical videos are characterised by an intense time dependency among phases, and pinpointing the phase transition areas is essential for discovering such dependency. To be able to give importance to previous key information, especially during phase transitions, our method LoViT projects transition points onto a heatmap H of length L using a one-dimensional left-right asymmetric Gaussian kernel, which is utilised to supervise the model.

An aspect of the disclosure provides a computer-implemented method of surgical video phase labelling, wherein the surgical video comprises a plurality of frames each defining a temporal point in the surgical video sequence, the method comprising one or more of: sampling a subset of frames from the plurality of frames of the surgical video; extracting spatial features from the subset of frames; performing local temporal feature extraction on the spatial features of the subset of frames of the surgical video to identify a sequence of frames that include local temporal information indicative of a surgical phase; performing global key information extraction on the sequence of frames that include local temporal information indicative of a surgical phase to identify whether global key information indicative of a surgical phase appears in a global sequence of frames; and combining the global key information and the local temporal information to form overall surgical phase information comprising one or more temporal points of interest in the surgical video sequence of surgical phase transition points.

This approach provides the benefit of being able to extract spatial features from short and long sequences of surgical video, as surgical videos can often span many hours with the majority of frames having very similar qualities. This approach improves the accuracy, reliability and robustness of detecting and labelling surgical phase transitions within both offline and live surgical video.

In some aspects, the method may further comprise: projecting the overall information that is indicative of surgical phase transition points onto a heatmap; confirming that the heatmap shows that the overall information is indicative of a surgical phase transition; and labelling the surgical phase in the surgical video if the overall information indicated a surgical phase transition had occurred as confirmed by the heatmap.

In some aspects, the heatmap may be produced using a one-dimensional Gaussian Kernel by using ground truth labels of surgical phase transitions.

In some aspects, the method may further comprise: using the one-dimensional Gaussian Kernel during training as guided supervision to improve the extraction of local temporal information and global key features and improving combination of said extracted local temporal information and global key features; and dropping the one-dimensional Gaussian Kernel during inference to assign a surgical phase label based on the local temporal information, global key features, and combined features.

In some aspects, the surgical video may be a live stream from an active surgery and the subset of frames of the surgical video contains past and present frames of the surgical video. As such, the one-dimensional Gaussian Kernel may be asymmetric and the Gaussian Kernel may provide a higher weighting factor to past and present frames of the surgical video in comparison to future frames of the surgical video.

In some aspects, the surgical video may be a prerecorded video of a surgery and the subset of frames of the surgical video may contain past, present and future frames of the surgical video. As such, the one-dimensional Gaussian Kernel may be symmetric and the one-dimensional Gaussian Kernel may provide an equal weighting factor to past, present and future frames of the surgical video.

In some aspects, the local temporal feature extraction may be performed by a transformer-based local temporal feature extractor to process short sequence inputs and process fine-grained local information. The transformer-based local temporal feature extractors may comprise embedded previously processed frames, such that the method may further comprise; comparing a current frame of the surgical video with embedded previously processed frames of the surgical video.

In some aspects, the global key information extraction may be performed by a global key recorder utilizing max-pooling to process the relationships of surgical phases spanning across long periods of time in a surgical video.

In some aspects, the combining of the extracted local temporal information and global key information may be performed by a fusion head which may comprise a transformer-based multi-scale fusion module.

In some aspects, the method may further comprise: encoding the global key information and the local temporal information such that the dimensions of the global key information and the dimensions of the local temporal information match prior to combining.

In some aspects, the global key recorder may apply a probability rating to each frame of the sequence of frames that include local temporal information, the probability rating may be indicative of the likelihood the frame contains a global key information.

In some aspects, the local temporal information may be indicative of one or more of actions, surgical tools, surgeon hands, operated organs. Further, the local temporal feature extraction may be performed by a local temporal feature aggregator.

In some aspects, the local temporal feature aggregator may comprise an m-layer self-attention encoder and an n-layer cascaded self-attention and cross-attention decoder.

In some aspects, the m-layer self-attention encoder may receive a first branch input and the n-layer cascaded self-attention and cross-attention decoder may receive a second branch input.

A further aspect of the disclosure provides a computer-implemented method of surgical video phase labelling, wherein the surgical video comprises a plurality of frames each defining a temporal point in the surgical video sequence, the method comprising: sampling a subset of frames from the plurality of frames of the surgical video; extracting spatial features from the subset of frames; performing local temporal feature extraction on the spatial features of the subset of frames of the surgical video on a first temporal scale to identify local temporal information over the first temporal scale indicative of a surgical phase; performing global temporal feature extraction on the spatial features of the subset of frames of the surgical video on a second temporal scale longer than the first temporal scale to identify global temporal information over the second temporal scale indicative of a surgical phase; and fusing the extracted local and global temporal information together to form overall surgical phase information comprising one or more temporal points of interest in the surgical video sequence that are indicative of surgical phase transition points.

This approach provides the benefit of being able to extract spatio-temporal information from short and long sequences of surgical video, as surgical videos can often span many hours with the majority of frames having very similar qualities. This approach improves the accuracy, reliability and robustness of detecting and labelling surgical phase transitions within both offline and live surgical video.

In some aspects, the method may further comprise: projecting the overall information that is indicative of surgical phase transition points onto a heatmap; confirming that the heatmap shows that the overall information is indicative of a surgical phase transition; and labelling the surgical phase in the surgical video if the overall information indicated a surgical phase transition had occurred as confirmed by the heatmap. Alternatively, the labelling of the surgical phase in the surgical video may occur during predictions after embedded features of local, global, and fusion models have been trained using the heatmap

The surgical phase in the surgical video may be labelled during predications using the overall information indicative of a surgical phase transition after the local feature extractor, global feature extractor and fusion of the extracted local and global temporal information have been trained using the heatmap and embedded with previously processed frames of the surgical video.

In some aspects, the heatmap may be produced using a one-dimensional Gaussian Kernel by using ground truth labels of surgical phase transitions. Further, in some aspects may further comprise: using the one-dimensional Gaussian Kernel during training as guided supervision to improve the extraction of local and global temporal features and improving fusion of said extracted local and global temporal features; and dropping the one-dimensional Gaussian Kernel during inference to assign a surgical phase label based on the local, global, and fused temporal features.

In some aspects, the surgical video may be a live stream from an active surgery and the subset of frames of the surgical video may contain past and present frames of the surgical video. As such, the one-dimensional Gaussian Kernel may be asymmetric and the Gaussian Kernel may provide or assign a higher weighting factor to past and present frames of the surgical video in comparison to future frames of the surgical video. Alternatively, the surgical video may be a prerecorded video of a surgery and the subset of frames of the surgical video may contain past, present and future frames of the surgical video. As such, the one-dimensional Gaussian Kernel may be symmetric and the one-dimensional Gaussian Kernel may provide or assign an equal weighting factor to past, present and future frames of the surgical video.

In some aspects, the local temporal feature extraction may be performed by a plurality of transformer-based local temporal feature extractors to process short sequence inputs and process fine-grained local information. As such, the transformer-based local temporal feature extractors may comprise embedded previously processed frames, the method may further comprise: comparing a current frame of the surgical video with embedded previously processed frames of the surgical video. To this extent, the plurality of transformer-based local temporal features extractors may be designed to extract different granularities of local temporal information. Further, the plurality of transformer-based local temporal feature extractors may be positioned in a cascaded arrangement.

In some aspects, the global temporal feature extraction may be performed by a global temporal informer to process the relationships of surgical phases spanning across long periods of time in a surgical video.

In some aspects, the fusing of the extracted local and global information may be performed by one or more transformer-based multi-scale fusion module. As such, the method may further comprise: fusing the different granularities of local temporal information using a first transformer-based multi-scale fusion module to form complete local temporal information; and fusing the complete local temporal information with the global temporal information using a second transformer-based multi-scale fusion module.

In some aspects, the performing local temporal feature extraction may seek to identify persistent local temporal information indicative of a surgical phase across the first temporal scale. Likewise, the performing global temporal feature extraction may seek to identify persistent global temporal information indicative of a surgical phase across the second temporal scale.

A further aspect of the disclosure provides a computer-implemented method of surgical video phase labelling, wherein the surgical video comprises a plurality of frames, the method comprising: performing spatio-temporal feature extraction on a surgical video to extract temporal information in the surgical video sequence indicative of a surgical phase transition; projecting the information that is indicative of surgical phase transition points onto a heatmap; confirming that the heatmap shows that the projected information is indicative of a surgical phase transition; and labelling the surgical phase in the surgical video if the projected information indicated a surgical phase transition had occurred as confirmed by the heatmap.

In some aspects, the heatmap may be produced using a one-dimensional Gaussian Kernel by using ground truth labels of surgical phase transitions. Moreover, the method may further comprise: using the one-dimensional Gaussian Kernel during training as guided supervision to improve the extraction of local and global temporal features and improving fusion of said extracted local and global temporal features; and dropping the one-dimensional Gaussian Kernel during inference to assign a surgical phase label based on the local, global, and fused temporal features.

In some aspects, the surgical video may be a live stream from an active surgery, and the one-dimensional Gaussian Kernel may be asymmetric such that the Gaussian Kernel may provide a higher weighting factor to past and present frames of the surgical video in comparison to future frames of the surgical video. Alternatively, the surgical video may be a prerecorded video of a surgery, and the one-dimensional Gaussian Kernel may be symmetric such that the one-dimensional Gaussian Kernel may provide an equal weighting factor to past, present and future frames of the surgical video.

In some aspects, the method may further comprise: comparing the extracted temporal information with embedded global key events that are embedded within a global key information extractor. Moreover, the global key information extractor may utilize max-pooling to record the global key events from a surgical video.

A further aspect of the disclosure provides a computer-implemented method of surgical video phase labelling, wherein the surgical video comprises a plurality of frames each defining a temporal point in the surgical video sequence, the method comprising: performing local spatio-temporal feature extraction on the surgical video on a first temporal scale to identify one or more local temporal points of interest in the surgical video sequence by extracting local spatio-temporal information indicative of a surgical phase; performing global spatio-temporal feature extraction on the surgical video on a second temporal scale longer than the first temporal scale to identify one or more global temporal points of interest by extracting global spatio-temporal information indicative of a surgical phase; and fusing the extracted local and global spatio-temporal information together to form overall surgical phase information comprising one or more temporal points of interest in the surgical video sequence that are indicative of surgical phase transition points.

Further features and advantages will be apparent from the appended claims.

### BRIEF DESCRIPTION OF THE DRAWINGS

Further features and advantages of the present invention will become apparent from the following description of an embodiment thereof, presented by way of example only, and with reference to the accompanying drawings, wherein like reference numerals refer to like parts, and wherein:

FIG. 1 shows example frames from the surgical video present in the Cholec80 dataset [2], which is a prior art dataset of surgical video imagery;

FIG. 2 shows the architecture of the LoVit framework according to the present disclosure;

FIG. 3 shows the architecture of our framework to train our proposed Temporally-Rich Spatial Feature Extractor according to the present disclosure;

FIG. 4 shows the architecture of the Local Temporal Transformer (L-Trans) framework according to the present disclosure;

FIG. 5 shows the architecture of the Global Temporal Module (G-Informer) framework according to the present disclosure;

FIG. 6 shows the architecture of the Multi-scale Temporal Fusion Module (MF-Trans) framework according to the present disclosure;

FIG. 7 shows a qualitative comparison of the performance of the present invention with the performance of other detection methods on the Cholec80 dataset [2];

FIG. 8 shows the architecture of the Gaussian kernel heatmap framework according to the present disclosure;

FIGS. 9a and 9b shows graphical representations of the output from the Gaussian Kernel or the heatmap-guided supervision when used with either pre-recorded (9a) or live (9b) surgical video, according to the present disclosure.

FIG. 10 shows the architecture of the LoVit framework according to the present disclosure;

FIG. 11 shows a first block diagram of a computer system for use with the LoViT framework according to the present disclosure;

FIG. 12 shows a second block diagram of a computer system for use with the LoViT framework according to the present disclosure;

FIG. 13 shows a flow diagram of the operation of the LoViT framework when detecting and labelling phase transitions in surgical video according to the present disclosure;

FIG. 14 shows a flow diagram of the training process for the LoViT framework according to the present disclosure;

FIG. 15 shows the architecture of the SKiT framework according to a further embodiment of the present disclosure;

FIG. 16 shows the architecture of the Key-recorder module according to a further embodiment of the present disclosure;

FIG. 17 shows a qualitative comparison of the performance of the further embodiment of the present invention with the performance of other detection methods on the Cholec80 dataset;

FIG. 18 shows a flow diagram of the operation of the SKiT framework when detecting and labelling phase transitions in surgical video according to the further embodiment of the present disclosure;

FIG. 19 shows a block diagram of a computer system for use with the SKiT framework according to the further embodiment of the present disclosure.

### DETAILED DESCRIPTION OF THE PREFERRED EMBODIMENTS

The present disclosure relates to a new surgical phase recognition method named LoVIT, which adopts video-clip level supervision to train a rich spatial feature extractor and then uses the Multi-scale temporal feature aggregator to combine local fine-grained and global macroscopic information to recognise surgical phases. Specifically, the Transformer-based LoViT allows detection and labelling of surgical phases in long video feeds with less loss of information than other existing methods. Moreover, our LoViT utilises a Gaussian Kernal heatmap to learn phase transitions, which is significant to predict and grab the relationship between phases.

### Temporally-Rich Spatial Feature Extraction

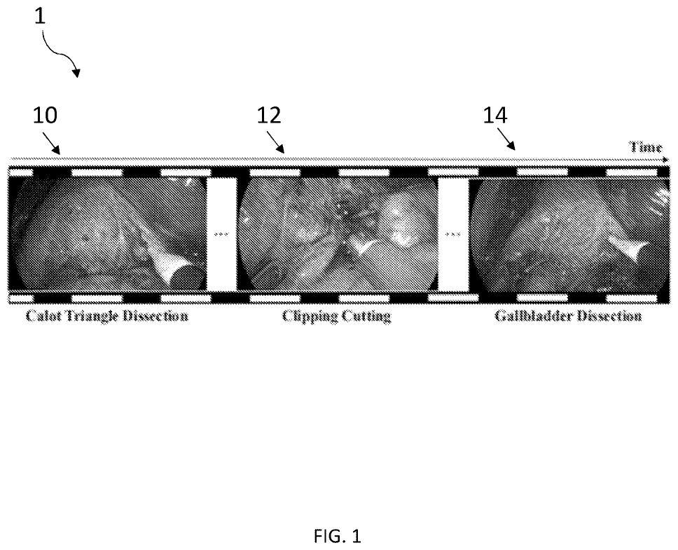

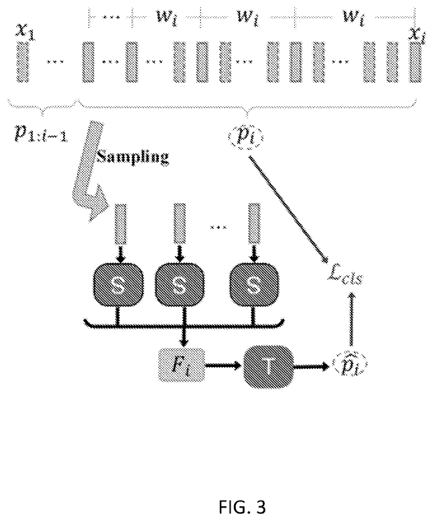

Current spatial feature extractors achieve good performance in general vision tasks. For surgical videos, similar actions, as observed from a collection of frames, could appear during different phases, causing a degree of ambiguity when classifying surgical phases, as illustrated in FIG. 1. As a result, frame-level supervision is insufficient for surgical phase recognition since confusion arises when training a spatial feature extractor module, a problem that can result in over-fitting. Given a video frame, it can be observed that past frames are important for distinguishing the phase of ambiguous frames and clips. To reduce such confusion, we propose a new method to train a temporally-rich spatial feature extractor, which is shown in FIG. 3. Specifically, we use spatial feature extractor S to extract the current and past frames into an embedding sequence F, which are used as inputs to an extra temporal aggregator T to classify surgical phases. Considering the limitations of computing resources and assuming the key temporal information generally appears at the beginning of every phase, we only select a small number a frames as input sequence, where frames are considered from the start of the current phase p^{s} up to the current frame fᵢ at an equal interval:

$${w}_{i} = ⌈ \frac{i - arg ( {p}_{i}^{s} )}{α} ⌉ : \qquad ( 1 )$$

$${F}_{i} = ( S ( {x}_{i - ( α - 1 ) {w}_{i}} ) , S ( {x}_{i - ( α - 2 ) {w}_{i}} ) , … , S ( {x}_{i} ) )$$

where xᵢ∈R^{H×W×C} refers to the image of the iₜₕ frame.

Then the predicted phase p\hat{ }ᵢ, of iₜₕ frame fᵢ is formulated as:

$$\hat{{p}_{ι}} = T ( {F}_{i} ) \qquad ( 2 )$$

To this end, inspired by the Transformer-based model AVT that performs efficiently in action anticipation tasks of short videos, we use the proposed architecture of AVT, whereby spatial feature extractor S is based on ViT and temporal aggregator T is based on a Transformer with causal-masked attention. Moreover, we use cross-entropy loss for training this model. Note that we drop out the temporal aggregator T after training the spatial feature extractor S.

### Multi-Scale Temporal Feature Aggregator

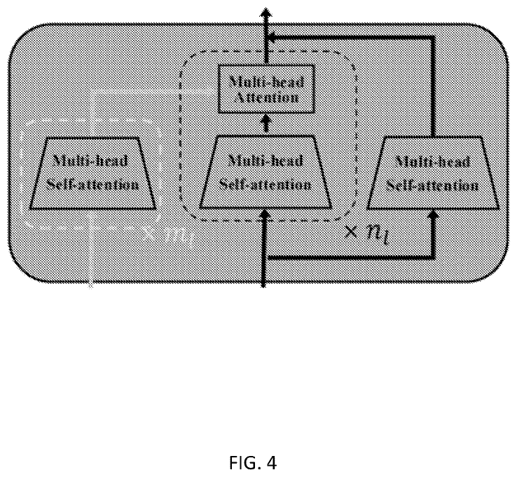

1) Local Temporal Feature Aggregator: The self-attention mechanism can reduce the length between every network signal to the shortest (1) through the dot-product computation between every two signals and avoid the recurrent structure, whereby Transformer shows great potential for temporal features aggregation. Accordingly, we design a transformer-based local temporal feature aggregator (L-Trans) to extract local fine-grained temporal information, which is visualized in FIG. 4.

Our L-Trans receives a short sequence of inputs fed by the spatial feature extractor module. We set sequence length θ to enforce the temporal feature extraction of the relationships among close frames and then optimize fine-grained features like actions, tools, and targets. Moreover, L-Trans also considers the previously processed frames as inputs since the information of adjacent clips is closely interconnected.

Specifically, L-Trans contains an mᵢ-layer self-attention model to embed previously processed frames and mᵢ-layer cascaded self-attention to process current features and the previous-to-current future fusion. Additionally, L-Trans connects one more self-attention layer processed current feature with previous-to-current fused future to avoid information loss. The self-attention mechanism as proposed in prior art is formulated as:

$$\text{?} ( Q , K , V ) = Softmax ( \frac{{QK}^{T}}{\sqrt{{d}_{k}}} ) V \qquad ( 3 )$$

where Q∈R^{L}^{_{Q}}^{×d}, K∈R^{L}^{_{K}}^{×d}, V∈R^{L}^{_{K}}^{×d} and d is the input dimension. Q, K, and V are the tuple inputs, and represent query, key, and value, respectively.

In order to extract the local temporal information of different granularities, we adopt two cascaded L-Transformer: a small one (Lₛ-Trans) and a large one (Lᵢ-Trans), to aggregate θ₁ and θ₂ frames, respectively. To speed up the training time and reduce the training memory, we only calculate the gradient of the last clip (x_{i-θ+1}, . . . , xᵢ) and drop all the previous gradients when recognising iₜₕ frame for training.

2) Global Temporal Feature Aggregator: To process long sequences of information from surgical videos, we propose to use a more efficient implementation of a Transformer-based architecture. Despite the self-attention mechanism inherent in Transformer-based architectures has the capability of extracting temporal relationships (see Eq. 3), vanilla self-attention requires quadratic time dot-product computation and O(L_{Q}L_{K}) memory usage, which curtails opportunities to process inputs of long sequences. To overcome these limitations, Transformer-based Informer observed that only a few dot-product pairs contribute to the major attention, a method the authors called ProbSparse. We consequently propose the integration of ProbSparse self-attention mechanism into LoVit to reduce the time complicity and memory usage to O(L In L).

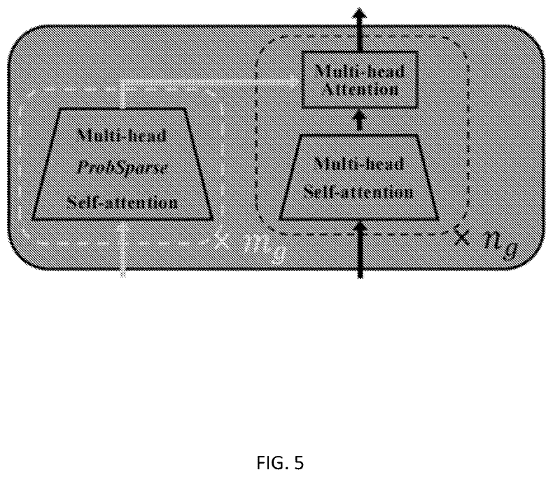

We designed a Global Temporal Informer (G-Informer) based on Informer to capture long-range dependencies more efficiently. The G-Informer framework, shown in FIG. 5, is similar to L-Trans, and it contains two blocks for two-branch inputs: 1) long local feature sequence (I₀, . . . , Iₜ), and 2) current local feature (I, . . . , Iₜ). In contrast to L-Trans, the block for long sequence adopts ProbSparse self-attention mechanism to reduce time complicity and memory usage and is formulated as:

$$\text{?} ( Q , K , V ) = Softmax ( \frac{\overline{Q} {K}^{T}}{\sqrt{{d}_{k}}} ) V \qquad ( 4 )$$

let qᵢ stand for the i-th row in Q, and then Q is a sparse matrix of the same size of q, and it only contains the Top-u queries under the sparsity max-mean measurement:

$$\overline{M} ( {q}_{i} , K ) = {max}_{j} ( \frac{{q}_{i} {k}_{j}^{T}}{\sqrt{{d}_{k}}} ) - \frac{1}{{L}_{K}} {\sum }_{j = 1}^{{L}_{K}} \frac{{q}_{i} {k}_{j}^{T}}{\sqrt{{d}_{k}}} \qquad ( 5 )$$

Under the long tail distribution, we randomly sample U=LK In LQ dot-product pairs to calculate the M (qi, K), and fill other pairs with zero.

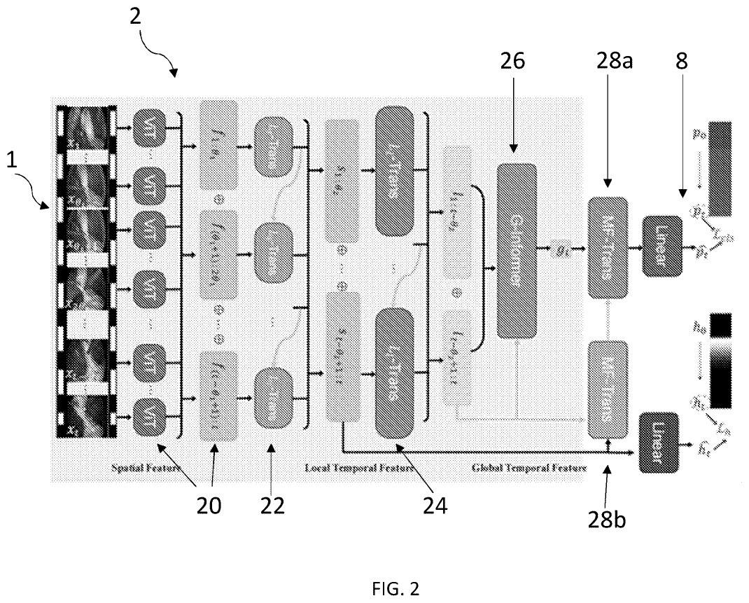

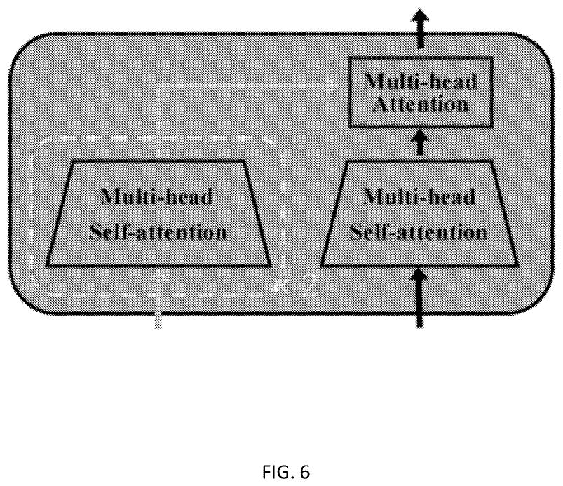

3) Multi-scale Temporal Feature Fusion Head: Since G-Informer will lose some fine-grained characteristics while down-sampling the features of the previous stage and getting sparse attention, we adopt a transformer-based multi-scale fusion module MF-Trans to fuse local and global features together that result from L-Trans and G-Informer. The purpose of this fusion model is to enforce the classifier to recognise current based on multi-scale temporal aggregation. As shown in the right of FIG. 2, we first use one MF-Trans to fuse two level cascading local temporal features, namely (s_{t-θ1}, . . . , sₜ) and (I_{t-θ1}, . . . , Iₜ), extracted by Lₛ-Trans and Lᵢ-Trans, respectively. Following that, another MF-Trans are used to fuse the fused local features with global temporal features (g_{t-θ1}, . . . , gₜ) extracted by G-Informer. Specifically, MF-Trans adopts a self-attention mechanism to receive two-branch inputs, which are shown in FIG. 6.

Efficient Multi-scale Temporal Feature Aggregator (Key-Recorder)

1) Local Temporal Feature Aggregator: Similar to the description above (section 1 under Multi-scale Temporal Feature Aggregator), we adopt a small local Transformer Ls (small)-Trans for abstracting short fine-grained information.

2) Global Key Information Extractor (Key Recorder): We introduce an efficient global model to cope with the time-consuming operations required by the Global Temporal Feature Aggregator (section 2 under Multi-scale Temporal Feature Aggregator) and the Multi-scale Temporal Feature Fusion Head (section 3 under Multi-scale Temporal Feature Aggregator) and replace them with a key events recorder for keeping track of global key events appearing in the long videos throughout time.

Specifically, Key-Recorder first builds an identity matrix E∈ [symbol] ^{L}^{ₑ}^{×L}^{ₑ} as the Key Template, where Eᵢ represents the iₜₕ key event the Key-Recorder should record. It then follows a linear function to get embedded key events. For the iₜₕ feature obtained after the previous Ls-Trans, we adopt dot-product it with the Key Template and get its responsiveness rt E [symbol] ^{L}^{ₑ} to all key events. We then propose a Key-Pooling or Max-Pooling mechanism motivated by CornerNet [4] to record the appeared key events. The output recorders g of Key-Pooling or Max-Pooling can be expressed by the following equations:

$${g}_{i}^{j} = \{ \begin{matrix}max ( {g}_{i - 1}^{j} , {r}_{i}^{j} ) , & i > 0 \\ {r}_{i}^{j} , & i == 0\end{matrix}$$

It is easy to find that Key-Pooling or Max-Pooling mainly uses comparisons to record the current maximum responsiveness, which represents whether each key event appeared or not. Key-Pooling reduces the time complexity of Key-Recorder to O(1). Compared with the previous O(L log L) time complexity of G-Informer (section 2 under Multi-scale Temporal Feature Aggregator), the efficiency of the Key-Recorder has been greatly improved.

### Heatmap-Guided Supervision

To be able to give importance to previous key information, especially during phase transitions, we project transition points onto a heatmap H of length L using a one-dimensional left-right asymmetric Gaussian kernel. The heatmap value of the iₜₕ frame is formulated as:

$${H}_{i} = \{ \begin{matrix}exp ( - \frac{{( i - arg ( {p}_{i}^{s} ) )}^{2}}{2 {σ}_{i}^{2}} ) , & arg ( {p}_{i}^{s} ) - 3 {σ}_{l} < i < arg ( {p}_{i}^{s} ) \\ exp ( - \frac{{( i - arg ( {p}_{i}^{s} ) )}^{2}}{2 {σ}_{r}^{2}} ) , & arg ( {p}_{i}^{s} ) < i < arg ( {p}_{i}^{s} ) + 3 {σ}_{r} \\ 0 , & otherwise\end{matrix}$$

Accordingly, the loss function of our proposed LOVIT model is a weighted sum of the heatmap loss and phase class loss:

$${L}^{*} = {L}_{1} ( \hat{H} ) + {L}_{CE} ( \hat{p} ) ,$$

Where L₁(Ĥ) refers to the Ly loss between predicted heatmap Ĥ and its ground truth H, and L_{CE}(\hat{p}) refers to cross-entropy loss between predicted phase \hat{p} and its ground truth p.

We extensively performed experiments on two publicly available surgical video datasets, namely Cholec80 [2] and Auto-Laparo [3], capturing cholecystectomy and hysterectomy surgical interventions, respectively. Cholec80 consists of 80 high-resolution, of either 1920×1080 or 854×480 pixels, laparo-scopic surgical videos with an average video duration of 39 minutes at 25 frames-per-second (fps). These databases are provided with manual annotations done by surgeons indicating the surgical phase each video frame belongs to and the tools appearing in the scene. Cholec80 videos consist of seven phases, including: preparation (0), calot triangle dissection (1), clipping cutting (2), gallbladder dissection (3), gallbladder packaging (4), cleaning coagulation (5), and gallbladder retraction (6). For this study, we only use phase annotations. For a fair comparison with previous methods, we kept intact the splitting of the dataset into first 40 videos for training and the remaining 40 videos for testing. Auto-Laparo consists of 21 videos with 7 phases, including preparation (1), dividing ligament and peritoneum (2), dividing uterine vessels and ligament (3), transecting the vagina (4), specimen removal (5), suturing (6), and washing (7), recorded at 25 Hz of a resolution of 1920×1080 pixels with an average video duration of 66 minutes. We split the dataset into 10 videos for training, 4 videos for validation and 7 videos for testing. Note that, similar to other works, we sampled both datasets into 1 fps and resized the frame size to 250×250 pixels.

Our method is implemented with the Py-Torch frame-work (available at: https://pytorch.org/). All experiments were carried out on an Intel Xeon W-2195 CPU (2.3 GHz), 125 GB RAM, and a single NVIDIA Tesla V100 GPU. For the spatial feature extractor, we selected α=30 frames as input to train AVT and then got its spatial feature extractor to embed every image, which is frozen when training our multi-scale temporal feature extractor. Following the AVT model, the spatial feature extractor is a 12-head, 12-layer transformer encoder model that uses the VIT-B/16 architecture, which is pretrained on ImageNet-1K (IN1k) with input image size of 248×248 pixels and output size of 768D representations. We train the AVT model with SGD+momentum using 1e6 weight decay and 1e4 learning rate for 35 epochs, with a 5 epoch warmup and 30 epochs of cosine annealed decay. After training the spatial feature extractor, we freeze its weights and use the model for inference when training the remaining components of the proposed LoVIT architecture. Specifically, we train LoViT with SGD+momentum using 1e5 weight decay and 3e4 learning rate for 50 epochs, with a 5 epoch warmup and 45 epochs of cosine annealed decay. During experiments, we feed LoViT with a fixed length of 3000 video frames. To make the training stage more efficient, we only calculate the last 01=100 frames' gradient for Lₛ-Transformer and ϑ₂=500 frames' gradient for Lᵢ-Transformer.

To investigate the performance of LoViT in comparison with state-of-the-art approaches, followed by extensive ablation experiments to demonstrate the effect its different components have on a surgical phase recognition task. In accordance with previous work, we use four frequently used benchmark measures in surgical phase recognition, namely Accuracy, Precision, Recall, and Jaccard. Accuracy refers to the percent of correctly recognized phases and is video-based, which decreases the effect of video length. However, the video class is imbalanced, and the short phases only have little impact on the whole video's accuracy. To evaluate our model in multiple dimensions, we further adapt class-(phase-) level Precision, Recall, and Jaccard, which represent positive predictive value, positive rate, and intersection rate of recognition versus ground truth, respectively.

To measure the effectiveness of our proposed method, we compare LoViT with other state-of-the-art methods related to action anticipation and surgical phase recognition tasks on Cholec80 and AutoLaparo datasets.

The quantitative comparison on Cholec80 dataset is organised in the top section of Table 1. AVT was re-implemented following the publicly available code released with their published manuscript. The results of the other state-of-the-art methods were extracted verbatim from their respective published work. Other state-of-the-art methods, including OperA were not considered in our study since they split the dataset for training and testing differently and have no publicly available code released in tandem with their manuscript. It can be observed in Table 1 that LoViT consistently outperformed other methods on all metrics with the exception of Precision on Cholec80 where it achieved third place after MTRCNet-CL and Trans-SVNet. Specifically, LoViT achieves higher performance than the current state-of-the-art benchmark reported by Trans-SVNet by a margin of 2.39% accuracy. Even compared with MTRCNet-CL, a method based on multi-task learning that requires additional information in the form of tool labels, LoVIT exhibited higher performance by a margin of 2.3% Accuracy. LoVIT also outperformed AVT, the champion model for action anticipation which is similar to phase recognition, by 4.77% Accuracy. In comparison with TransSVNet, MTRCNet-CL, and AVT, we observed that our model also exhibits lower standard deviation of Accuracy of approximately 1.5%.

The quantitative comparison on AutoLaparo dataset is depicted in the bottom section of Table 1. For AVT, we re-implement it using the released code and copy the results directly following the, where most of these reported methods come from the same team with it, so we believe these results are convincing. We observe that TMRNet, TeCNO, and Trans-SVNet perform similarly on this dataset with average performance of 77%. Evidence suggests that AutoLaparo is more challenging because of the smaller dataset size with a more complex workflow. Compared to the state-of-the-art method Trans-SVNet, we observed LoViT had a higher performance with a 3.14% accuracy margin. Besides video-level Accuracy, we highlight that reported phase-level metrics are crucial due to the imbalance of phase distribution. Compared with Trans-SVNet, LoViT achieved an improvement of 20.86% (64.21% 85.07%), 3.74% (62.11%→65.85%), and 5.25% (50.65%→55.90%) related to Precision, Recall, and Jaccard, respectively. In summary, LoViT consistently outperformed in both video-level and phase-level as evidenced by these evaluation metric results.

TABLE 1
The results (%) of different state-of-the-art methods
on both the CHOLEC80 and AUTOLAPARO datasets

| Dataset | Methods | Accuracy | Precision | Recall | Jaccard |
|---|---|---|---|---|---|
| Cholec80 | EndoNet* | 81.7 ± 4.2 | 73.7 ± 16.1 | 79.6 ± 7.9 | — |
| | MTRCNet-CL* | 89.2 ± 7.6 | 86.9 ± 4.3 | 88.0 ± 6.9 | — |
| | PhaseNet | 78.8 ± 4.7 | 71.3 ± 15.6 | 76.6 ± 16.6 | — |
| | SV-RCNet | 85.3 ± 7.3 | 80.7 ± 7.0 | 83.5 ± 7.5 | — |
| | OHFM | 87.3 ± 5.7 | — | — | 67.0 |
| | TeCNO | 88.56 | 81.64 | 85.24 | — |
| | Trans-SVNet | 89.11 ± 7.03 | 84.72 | 83.63 | 72.50 |
| | AVT | 86.73 ± 7.62 | 77.34 | 82.13 | 66.42 |
| | LoViT (ours) | 91.50 ± 6.10 | 83.07 | 86.5 | 74.15 |
| AutoLaparo | SV-RCNet | 75.62 | 64.02 | 59.70 | 47.15 |
| | TMRNet | 78.20 | 66.02 | 61.47 | 49.59 |
| | TeCNO | 77.27 | 66.92 | 64.60 | 50.67 |
| | Trans-SVNet | 78.29 | 64.21 | 62.11 | 50.65 |
| | AVT | 77.81 ± 9.38 | 68.04 | 62.23 | 50.66 |
| | LoViT (ours) | 81.43 ± 7.35 | 85.07 | 65.85 | 55.90 |

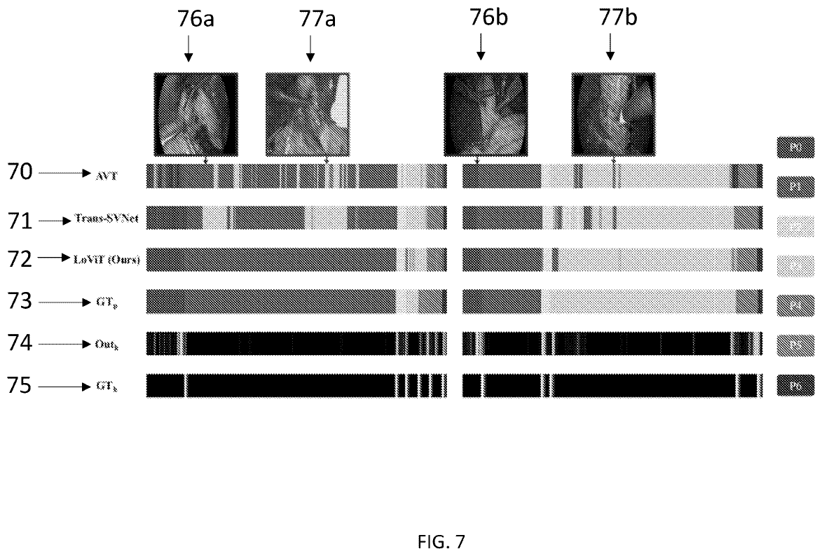

To illustrate the performance of our approach in comparison with the state-of-the-art, in FIG. 7 we present a qualitative comparison of two examples drawn from the Cholec80 testing dataset. As observed in FIG. 7, for some ambiguous frames shown (first row), Trans-SVNet was unable to classify the correct phase effectively. Even though the surgical phases of laparoscopic cholecystectomy are linearly executed, video frames are misclassified to phases that are strictly nonlinear. In contrast, LoViT learned a better long-term temporal context than Trans-SVNet, even when a few misclassifications are still nonlinear. Even for some examples (first row with dark red box), Trans-SVNet performs worse than AVT which uses short video clips as inputs. This further proves that Trans-SVNet loses some fine-grained and continuity information while processing long videos. When investigating the performance in learning the heatmap capturing phase transitions, we observed that LoViT's performance is highly accurate compared to the ground truth, as shown in the last two rows of FIG. 7. In our ablation studies, we demonstrate the benefit of including heatmap information since it further helps extracting relationships among phases.

TABLE 2
Effects (%) of Rich Spatial Feature Extractor
(R) on CHOLEC80 and AutoLaparo datasets

| Dataset | R | Accuracy | Precision | Recall | Jaccard |
|---|---|---|---|---|---|
| Cholec80 | | 90.66 ± 6.89 | 80.81 | 85.21 | 71.42 |
| | ✓ | 91.50 ± 6.10 | 83.07 | 86.5 | 74.15 |
| AutoLaparo | | 79.53 ± 8.36 | 79.61 | 64.85 | 53.74 |
| | ✓ | 81.43 ± 7.35 | 85.07 | 65.85 | 55.90 |

TABLE 3
Effects (%) of heatmap Guided Supervision
(H) on CHOLEC80 and AUTOLAPARO datasets

| Dataset | H | Accuracy | Precision | Recall | Jaccard |
|---|---|---|---|---|---|
| Cholec80 | | 90.07 ± 5.98 | 82.23 | 84.58 | 71.67 |
| | ✓ | 91.50 ± 6.10 | 83.07 | 86.5 | 74.15 |
| AutoLaparo | | 77.86 ± 7.88 | 71.03 | 64.78 | 52.56 |
| | ✓ | 81.43 ± 7.35 | 85.07 | 65.85 | 55.90 |

TABLE 4
The results (%) of different parts of the proposed
LoViT on both the CHOLEC80 and AUTOLAPARO datasets

| Dataset | Models | Accuracy | Precision | Recall | Jaccard |
|---|---|---|---|---|---|
| Cholec80 | L-Trans G- | 90.81 ± 5.85 | 82.51 | 86.48 | 72.92 |
| | Informer | 91.52 ± 5.76 | 83.29 | 86.98 | 74.55 |
| | LoViT | 91.50 ± 6.10 | 83.07 | 86.5 | 74.15 |
| AutoLaparo | L-Trans G- | 80.60 ± 6.93 | 69.70 | 65.08 | 54.02 |
| | Informer | 79.75 ± 7.32 | 70.33 | 63.64 | 53.43 |
| | LoViT | 81.43 ± 7.35 | 85.07 | 65.85 | 55.90 |

We studied the effects of different modules that are part of our proposed model. Specially, LoViT is composed of three modules: 1) local temporal feature aggregator L-Trans, 2) global temporal feature aggregator G-Informer, and 3) Multi-scale temporal feature fusion module MF-Trans. Accordingly, we conducted the following experiments to measure their contributions to the overall performance:
L-Trans. In this experiment, we measure the performance of the time aggregation model when only contains L-Trans module to grab local fine-grained features but without the integration of global relationship.
G-Informer. In this experiment, we measure the performance of a model that includes the time aggregation by the G-Informer module following the L-Trans. Then, the coarse-grained information outputted by G-Informer is directly fed into the classifier.
LoViT. In this experiment, we measure the performance of our full LoViT model, i.e. including the temporal local and global transformers followed by a multi-scale temporal fusion head.

The quantitative experiment results are shown in Table 4.

From the results of L-Trans and G-Informer, we can observe that the L-Trans performed better on the Cholect80 dataset but G-Informer performances better on the AutoLaparo dataset, which prove the global macro relationship is more helpful for recognising the videos of Cholect80 but fine-grained features for AutoLaparo. Most of the videos in AutoLaparo contain recurring phases, and the workflow in the Cholect80 videos is much more stable. Accordingly, global relationships and fine-grained features are more critical to Cholect80 and AutoLaparo, respectively, consistent with the experimental results. Comparing the performance of LoViT and the other two experiments, the performance of LoViT is comparable to G-Informer in Cholec80 and only slightly inferior. But LoViT makes a great improvement over the rest two models in AutoLaparo. Overall, LoViT performs better and more stable, which is evident that the feature map g produced by G-Informer will lose some fine-grained information than I extracted by L-Trans, and fusing these multi-scale features s and g can help model analyse every frame from different dimensions, and then further improve the recognition accuracy.

As depicted in Table 2, we show the effect of our rich spatial feature extractor. In this table, one can observe that the rich spatial feature extraction that uses video clips as inputs does contribute to higher performance. This increase in performance is more evidently seen on the AutoLaparo dataset with an improvement of 1.9% in Accuracy. Moreover, we observe that even the performance of LoViT without such rich spatial feature extractor still outperforms the state-of-the-art.

We evaluate the influence of our proposed heatmap for better learning phase transitions of surgical videos. As shown in Table 3, the supervision of the heatmap makes a great improvement on both datasets, which further proves that phase transition areas of surgical videos contain important flags for the start and end of every phase, which is vital to grab phases relationships and reduce the confusion of some similar clips.

First, spatial feature extractor networks are typically trained for surgical phase recognition using image-only level supervision due to limited computing resources. However, our work indicates that a temporally-rich spatial feature extractor is essential for supporting an accurate recognition network. In this application, we demonstrate that our temporally-rich spatial feature extractor on two datasets whilst having video clips as inputs is better than image-only level supervision for training a spatial feature extractor. This approach is particularly beneficial for surgical videos since there might be a large number of frames with similar characteristics across different phases due to some scenes changing only slightly and showing a limited amount of tools. We illustrate this in FIG. 7 with scenes having similar spatial features and actions occasionally appearing at different phases (classes), resulting in the extractor being confused and in our model to over-fit because different labels supervise the same spatial features. Since key information in surgical videos is generally found at the beginning of every phase for distinguishing the phase of a given frame, we select a few frame images from the beginning of current phase to the current frame that we are aiming to classify at equal distances as input, whilst having the current frame's phase label as output to train our rich spatial feature extractor. By doing this, our model retains the key temporal information to recognize the phase of the current frame on the limitation of memory capacity.

Second, similar to the abovementioned problem of frame-level versus video clip-level supervision, similar actions occasionally appear at different surgical phases. Therefore, surgical phase recognition requires models that can process long sequences of video frames and extract their temporal relation-ships since interventions are typically long, generally lasting between one to two hours for cholecystectomy (Cholec80) and hysterectomy (AutoLaparo), whilst other interventions could even last longer, especially when complications arise. Despite the two most recent state-of-the-art methods for surgical phase recognition, namely TeCNO and Trans-SVNet, are able to process long videos using TCN, their dilated temporal aggregation approach is unable to cope with misclassifications of surgical phases. In this work, we adopted a Transformer-based model to aggregate temporal features, including vanilla self-attention mechanism for local short video clips and ProbSparse self-attention mechanism for global long video, which outperforms TeCNO and Trans-SVNet. Moreover, even Trans-SVNet didn't perform as well as AVT, a method that could only input short videos. Accordingly, from our results, it is suggested that dilated convolution operations that are part of TCN result in the model losing fine-grained features and continuous information. In this way, vanilla and ProbSparse self-attention operations demonstrate better performance over TCNs within the scope of our study. Third, surgical videos are characterised by an intense time dependency among phases and pinpointing the phase transition areas is essential for discovering such dependency. We are the first to attempt to present phase transitions with a Gaussian kernel heatmap, which is utilised to supervise the model. From the experimental results, we can find that heatmap unexpectedly dramatically improves the model's performance.

Heatmap-guided supervision is an easy operation and does not impose an additional processing burden on the model.

Last, considering the experiment results on datasets Cholec80 and AutoLaparo, we could easily find that AutoLaparo is more challenging than Cholec80. Apart from the lower performances of all methods on AutoLaparo, we found that different previous methods performed similarly on it. However, our LoViT significantly improved than TMRNet, TeCNO, and Trans-SVNet. Specifically, it's proved that local information is more valuable than the global relationship in the experimental results. Most videos in AutoLaparo contain repeated phases, which causes more complex phase relationships than videos in Cholec80. Accordingly, we think it is difficult for models to learn such phase relationships using fewer videos than Cholec80.

We demonstrate a new surgical phase recognition method named LoVIT, which adopts video-clip level supervision to train a rich spatial feature extractor first and then uses the Multi-scale temporal feature aggregator to combine local fine-grained and global macroscopic information to recognise phases. Specifically, our Transformer-based LoViT allows long video feeds with less loss of information than other existing methods. Moreover, our LoViT utilises the heatmap to learn phases transition, which is significant to grab the relationship between phases. The proposed LoViT achieves state-of-the-art performance with great improvement over existing methods.

Though LoViT shows superior performance, it's difficult for LoVIT to accurately recognise some phases that appear in an unusual operation process. As shown in the left video of FIG. 7, P5 appears after P4 in most scenes, but it appears before P4 in this video, which is difficult to recognise for a data-driven LoVIT, and it also remains a problem for other recognising methods.

Further details of the arrangements of the present disclosure will become apparent from the following detailed description made with respect to the Figures.

Reference is made to FIG. 1 wherein example frames 1 from different surgical phases of the Cholec80 training dataset can be seen. This figure seeks to highlight the difficulty and challenges faced by machine learning models when attempting to detect surgical phases and surgical phase transitions from surgical video. In FIG. 1, three surgical phases are shown: the Calot Triangle Dissection 10 phase, the Clipping Cutting 12 phase and the Gallbladder Dissection 14 phase. Despite the Calot Triangle Dissection 10 phase and Gallbladder Dissection 14 phase being vastly different surgical phases, the spatial features present in the frames from the Cholec80 dataset are very similar. This similarity in spatial features makes automatic detection of surgical phases and transitions difficult and thus, forms a key problem or challenge that the present disclosure seeks to overcome.

With reference to FIGS. 2-8, an embodiment of the present disclosure which seeks to overcome the above challenges can be seen. FIG. 2 shows the architecture of the LoViT framework 2 for phase recognition of surgical videos, wherein the surgical video comprises a plurality of frames with each frame comprising a plurality of points.

Firstly, the Spatial Feature Extractor 20 or the Temporally-rich Spatial Feature Extractor 20 is shown on the left-hand side of FIG. 2, wherein the example surgical frames 1 of the surgical video can be seen, as in FIG. 1. The Spatial Feature Extractor 20 is used to extract the current and previous surgical frames from the surgical video and arrange them in an embedding sequence, F. This embedded sequence forms the input to a temporal aggregator, T, as shown in FIG. 3, which seeks to classify the surgical phases. Considering the limitations of computing resources and assuming the key temporal information generally appears at the beginning of every phase, we only select a small number a frames as input sequence, where frames are considered from the start of the current phase p^{s} up to the current frame fᵢ at an equal interval. The predicted surgical phase is then expressed from this. Cross entropy loss is used for the training of this model, however, it is worth noting that once the Spatial Feature Extractor 20 is fully trained the temporal aggregator, T, is dropped out of the framework.

The Spatial Feature Extractor 20 provides an improvement on architecture that is image-only based, as it is capable of performing feature extraction from video inputs. This approach is particularly beneficial for surgical videos due to the nature of the surgical videos. Surgical videos can be very long, in some instances lasting many hours. Moreover, these long videos may show many frames with large amounts of similarity despite being during different surgical phases, as highlighted in reference to FIG. 1.

Next in the LoViT framework 2, the Multi-scale Temporal Feature Aggregator is shown. This is formed of two transformer-based local temporal feature aggregators, namely, Ls-Trans 22 and Lᵢ-Trans 24. The purpose of the local temporal feature aggregators 22 and 24 is to extract local fine-grained temporal information or spatio-temporal information and points of interest from the short sequence of inputs fed from the spatial feature extractor 20, as visualised in FIG. 4. The sequence length of the local temporal feature aggregators 22, 24 are set accordingly, to ensure that they extract the relationships among close proximity frames and optimize the fine details such as actions, tools and targets. Moreover, the temporal feature aggregators 22, 24 also considers the previously processed frames as inputs since the information of adjacent clips is closely interconnected. In order to extract the maximum amount of fine data from the input sequence the local temporal feature aggregators are cascaded and are set-up to extract different granularity levels of information. For example, Lₛ-Trans 22 may be the first local temporal feature aggregator and be setup to extract very fine granularity information from the input sequence. Lᵢ-Trans 24 may then be the second local temporal feature aggregator and as such be setup to information of a larger granularity than Lₛ-Trans 22. FIG. 4 shows the architecture of the local temporal transformer frameworks. In order to process two-branch temporal inputs the L-Trans adopts vanilla self-attention mechanism.

To extract information from and process long sequences of information from surgical videos, the present disclosure highlights a more efficient implementation of a transformer-based architecture. In transformer-based architectures the self-attention mechanism is inherent in order for the transformer-based architectures to have the capability of temporal relationship data extraction, vanilla self-attention requires quadratic time dot-product computation and O(L_{Q}L_{K}) memory usage, which largely prevents opportunities to process inputs of long sequences from surgical video. The present disclosure incorporates a Global Temporal Informer (G-Informer) 26 which seeks to capture long-range dependencies more effectively by extracting global temporal information or global spatio-temporal information. The framework of the G-Informer 26 is shown in FIG. 5 and is similar to the L-Trans as shown in FIG. 4. In contrast to L-Trans, the block for long sequence adopts ProbSparse self-attention mechanism to reduce time complicity and memory usage.

Since the G-Informer 26 seeks to extract the relationships, data and points of interest from long sequences it will lose some more fine-grained characteristics while down-sampling the features of the previous stage and getting sparse attention. To combat this, the present invention adopts a transformer-based multi-scale fusion module, MF-Trans, 28a-b to fuse local and global features together that result from L-Trans 22, 24 and G-Informer 26. The intent of this fusion model is to enforce the classification of current data based on multi-scale temporal aggregation i.e. fine-grained relationships and data and relationships and data extracted from the long sequence video. As shown in the right of FIG. 2, we first use one MF-Tran or the first transformer-based multi-scale fusion module 28a to fuse two level cascading local temporal features, namely (s_{t-θ1}, . . . , sₜ) and (I_{t-θ1}, . . . , Iₜ), extracted by Lₛ-Trans and Lᵢ-Trans, respectively. Following that, another MF-Trans or the second transformer-based multi-scale fusion module 28b is used to fuse the fused local features with global temporal features (g_{t-θ1}, . . . , gₜ) extracted by G-Informer. Specifically, MF-Trans adopts a self-attention mechanism to receive two-branch inputs, which are shown in FIG. 6.

This Global Temporal Informer (G-Informer) 26 allows the system to aggregate temporal features, including vanilla self-attention mechanism for local short video clips and ProbSparse self-attention mechanism for global long video. This outperforms other systems available, such as TeCNO and Trans-SVNET that process long video using TCN, as our results suggest that dilated convolution operations that are part of TCN result in the model losing fine-grained features and continuous information. In this way, vanilla and ProbSparse self-attention operations demonstrate better performance over TCNs as the present invention can utilize continuous information from global long video in conjunction with local fine-grained features. This provides a model with greater accuracy and robustness.

The system also includes heatmap-guided supervision 8 which seeks to highlight the importance and pertinence of previous key information during the differing surgical phases and phase transitions. The heatmap-guided supervision 8 is achieved using a Gaussian kernel. This allows us to project surgical phase transition points onto a heatmap, where the loss function of the LoViT model is a weighted sum of the heatmap and phase class loss.

FIG. 7 shows qualitative comparisons of the performance of the present invention (LoViT) in comparisons with some other methods (AVT and Trans-SVNet) on the Cholec80 dataset. The comparisons are shown via the various rows associated with the training images from the Cholec80 dataset. For example, the AVT performance is shown in row 70, the Trans-SVNet performance is shown in row 71 and the present invention, LoViT is shown in row 72. Row 73 depicts the corresponding Ground Truth, GT_{P}. Rows 74 and 75 depict the output of the Gaussian heatmap presented in the present invention and the associated Ground Truth, GT_{b}, respectively. The key for the different phases, P1-P6, that appear in the Cholec80 dataset can be seen on the far-right hand side of FIG. 87. Images 76a-b and 77a-b are associated surgical phase images from the Cholec80 at specific intervals of time. Images 76a and 76b show errors in the Trans-SVNet example, as it can be seen at row 71 that at the times associated with images 76a and 76b the Trans-SVNet system is misinterpreting the phase of the surgical video in comparison with the ground truth of row 73. Images 77a and 77b show times where both the Trans-SVNet 71 and the AVT 70 methods are misinterpreting the surgical video in comparison to the ground truth of row 73. From this comparison the present invention of LoVIT 72 most accurately interprets the phase transitions of the surgical video when compared to the ground truth 73.

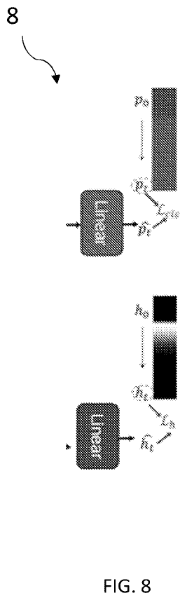

FIG. 8 shows the architecture of the Heatmap-guided supervision 8. Firstly, it is important to highlight the fundamentals of the Gaussian Kernel that makes up the heatmap-guided supervision 8. In the Gaussian Kernel, each radial basis function (RBF) neuron computes a measure of the similarity between the input and its associated training data set. Input vectors which are more similar to the associated training data give a result closer to 1 i.e., input vectors or surgical video frames that are more similar to video frames containing surgical phase transitions in the training data. It is worth noting that the largest response will occur when the inputted surgical video frames are equal to the training data video frame vector. Again, this shows a degree of similarity between the two and further the sum of all the RBF neurons will give a broader result.

Fundamentally, the Gaussian system seeks to build a convolution matrix i.e., a matrix of integer values associated with each RBF neuron of the frame of the surgical video. Each of these neurons is set a weighted average in accordance with the surrounding neurons. The original neurons value receives the highest Gaussian value or greatest weighting, and surrounding neurons receive smaller weights as their distance to the original neuron grows. This effect seeks to highlight and maintain object boundaries and edges within the frame better. In theory, every single neuron within the surgical video frame will have an associated non-zero integer in the matrix. This would mean that every neuron in the frame would need to be included in the calculations. However, in practice as neuron distance increases beyond a certain level the neuron has such a minute effect on the result, these neurons can be considered effectively zero.

In other words, Gaussian kernels of differing sizes are produced for the associated positions or neurons of the surgical video frame through the concentration of information with the fused local and global information already extracted from the surgical video. A centre point or a point of interest is highlighted on the surgical video frame i.e., the coordinate with the highest value. Around this point of interest, the nearby neurons are multiplied by each element of the two-dimensional Gaussian kernel. The varying values now associated with the neurons of the surgical video frame are assigned differing colours to create the Gaussian Kernel heatmap. This will further highlight areas of interest within the surgical video that may highlight surgical phase transitions.

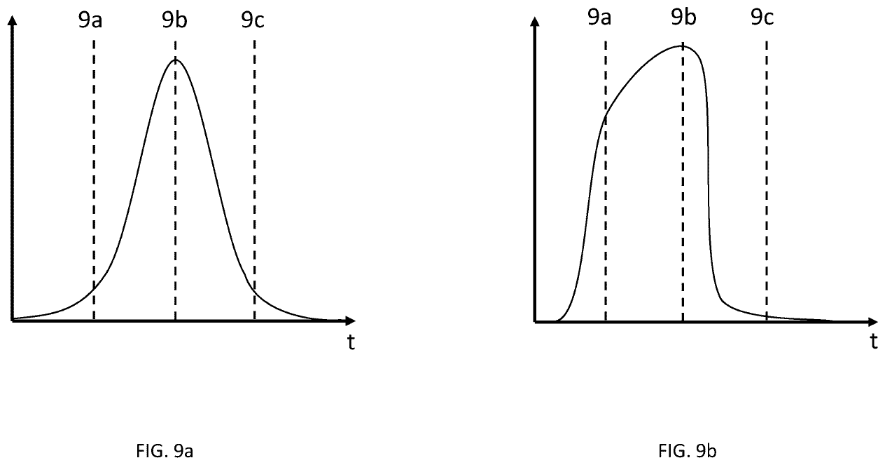

FIGS. 9a and 9b shows graphs of the output from the Gaussian Kernel or the heatmap-guided supervision. FIG. 9a seeks to indicate a surgical phase transition and the confidence level of the heatmap-based supervision output that a phase transition is occurring. Lines 9a-9c seek to highlight the challenge of detecting phase transitions in surgical video, as any of lines 9a-9c could be chosen as the point at which a surgical phase transition has occurred, since there is no discrete point at which a surgical phase transition has occurred especially given the large amounts of similarity between many different frames of surgical video. It is the aim to detect and label the surgical phase transitions as close to the line 9b point as possible, to ensure the highest confidence and therefore the highest accuracy of labelling. As can be seen by the curve in FIG. 9a, the output or response from the Gaussian Kernel in this instance is a symmetric response. Given this graph is showing the output over time, this highlights that an equal weighting factor is given to the past (i.e., information from surgical frames that have already occurred) and the future (i.e., information from surgical frames that have not occurred). Due to this, it is clear that this symmetric response is only possible when the LoViT is working with offline or prerecorded surgical videos as this allows the LoViT system to have access to both past, present and future frames of the surgical video. On the contrary, FIG. 9b shows a one-dimensional left right asymmetric Gaussian kernel, output or response. This shows a skew or higher weighting factor towards the information from the past i.e., surgical frames that have already occurred and that have been obtained now, in the present, but subsequently, putting little to no weighting on what information may lie in the future on the surgical video (which has yet to be captured). Therefore, this is the likely output from the Gaussian Kernel when utilizing the system with live surgical video. This is because in this scenario, the LoViT system does not have access to the surgical video in the future and solely must rely on the past and present information or frames of the surgical video. Moreover, the Gaussian heatmap output provides the benefit of being able to identify possible start and end points of surgical transitions from the Gaussian response. This allows the system to be able to start to detect surgical phase transitions earlier and with more confidence.

It is worth noting that during the operation of the LoViT system on either live or prerecorded surgical video, the Gaussian Kernel will be sampling and outputting these symmetric or asymmetric outputs throughout at a given frequency in order to accurately decipher and detect when surgical phase transitions are occurring within the video.

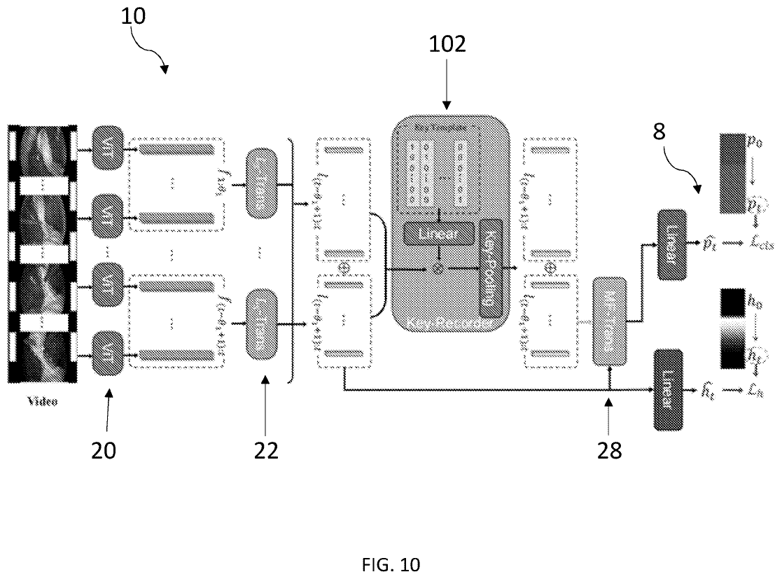

FIG. 10 shows the architecture of a second embodiment of the present invention, namely SKIT 10. As can be seen, there are many likenesses to the architecture of the first embodiment. For example, the second embodiment consists of the same Spatial Feature Extractor 20, local temporal feature aggregator 22, transformer-based multi-scale fusion module 28a-b and the same heatmap-guided supervision 8. The main difference between the second embodiment of FIG. 10 and the first embodiment of FIG. 2 is through the presence of the Key-Recorder 102. In other words, we replaced the large local Transformer Ll-Trans and global Informer G-Informer with an efficient key information recorder K-Recorder 102, which is shown as FIG. 10. This new model replaces the time-consuming temporal aggregator modules with an efficient key information pooling or max-pooling operation, which records the appeared key information and forgets the disturbing information. The proposed key-pooling or max-pooling is calculated by max operation from the beginning of the video to the current frame. Specifically, we build a few key information templates, match every spatial feature with them, and then employ the key-pooling to record key information. Initial experiments on Cholec80 showed that similar frame-level accuracy of 90.2% is achieved using key pooling (FIG. 10) compared to our original LoViT (FIG. 2) that has an accuracy of 90.5%, yet with more efficient inference resulting from a lower number of parameters to learn.

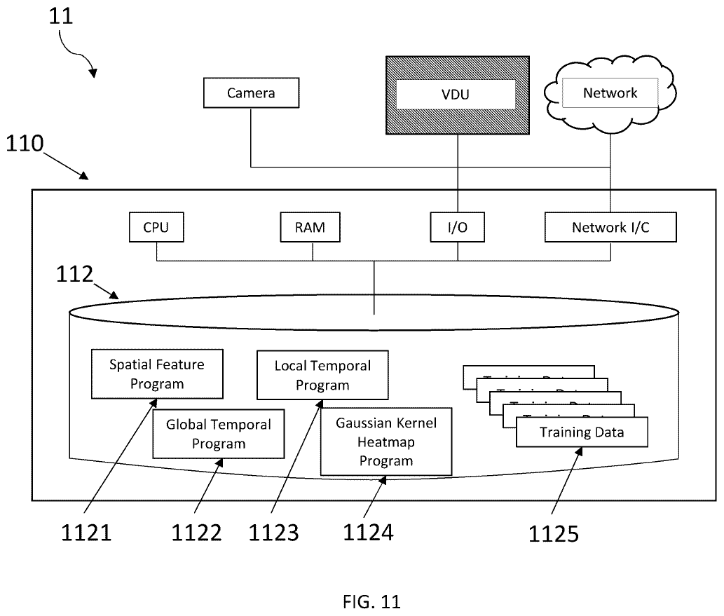

FIG. 11 is a block diagram of a typical general purpose computer system 11 that can form the processing platform for the LoViT surgical video phase detection and labelling, as described, according to a first embodiment. The computer system 11 comprises a central processing unit (CPU), random access memory (RAM), and input/output ports (I/O) into which data can be received and output therefrom as is well known in the art. Additionally included is a camera unit which may be positioned to record live surgical video, a visual display unit and a network access point for sending or receiving data including the receiving of prerecorded surgical video. Although, many further appliances could be used if necessary.

The computer system 11 also includes some non-volatile storage 112, such as a hard disk drive, solid-state drive, or NVMe drive. Stored on the non-volatile storage 112 is a number of executable computer programs together with data and data structures required for their operation or training. Overall control of the system 11 is undertaken through the execution of the Spatial Feature program 1121, the Global Temporal program 1122, the Local Temporal Program 1123 and the Gaussian Kernel Heatmap program or heatmap-based supervision program 1124. The other data contained in the non-volatile storage 112 is the surgical video training data 1125 which could be include, but is not limited to, the Cholec80 or AutoLaparo datasets.

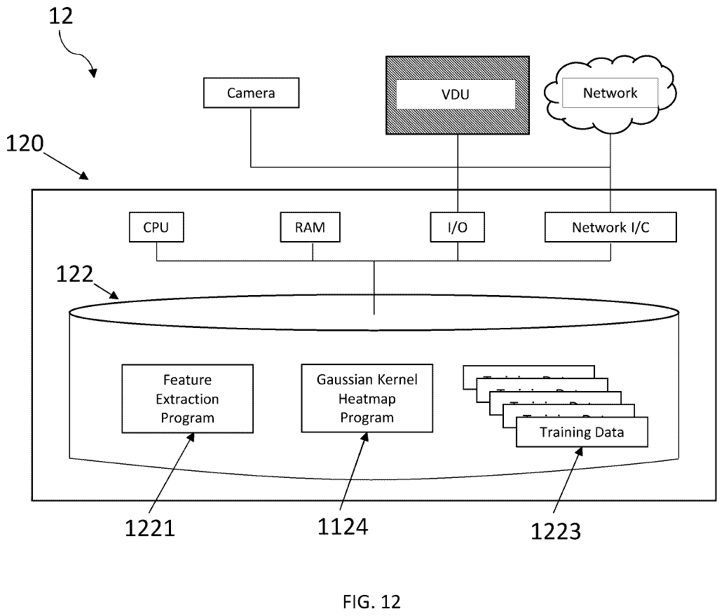

FIG. 12 is a block diagram of a typical general purpose computer system 12 that can form the processing platform for the LoViT surgical video phase detection and labelling, as described, according to a third embodiment. The computer system 12 comprises a central processing unit (CPU), random access memory (RAM), and input/output ports (I/O) into which data can be received and output therefrom as is well known in the art. Additionally included is a camera unit which may be positioned to record live surgical video, a visual display unit and a network access point for sending or receiving data including the receiving of prerecorded surgical video. Although, many further appliances could be used if necessary.

The computer system 12 also includes some non-volatile storage 122, such as a hard disk drive, solid-state drive, or NVMe drive. Stored on the non-volatile storage 122 is a number of executable computer programs together with data and data structures required for their operation or training. Overall control of the system 12 is undertaken through the execution of the Feature Extraction program 1221 and the Gaussian Kernel Heatmap program or heatmap-based supervision program 1124 (as in FIG. 11). The other data contained in the non-volatile storage 122 is the surgical video training data 1223 which could be include, but is not limited to, the Cholec80 or AutoLaparo datasets.

The computer-implemented system is applicable with a plethora of devices i.e., devices that are capable of processing large video files. The devices should be capable of at least receiving, processing, analysing, and storing of data that is extracted from surgical video. Therefore, devices that are applicable for use in this system are not limited to, but at least include:
desktop computers
laptop computers
mobile telephones
tablet computers

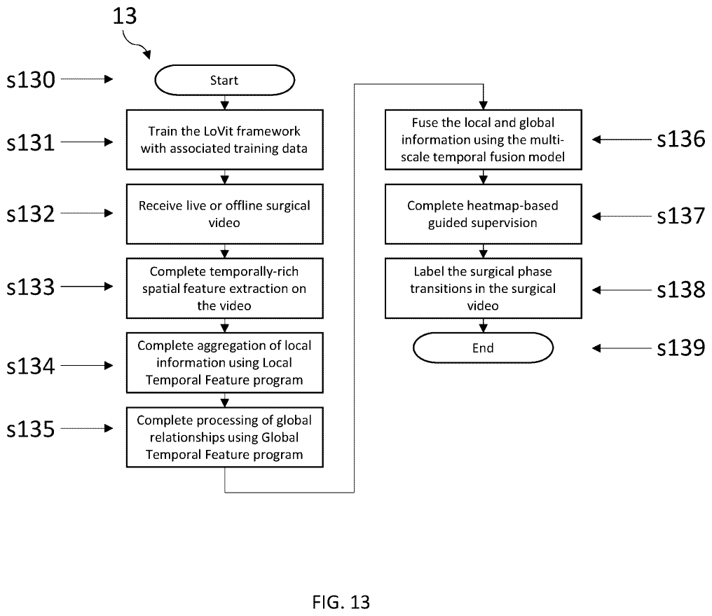

FIG. 13 shows a flow diagram for the operation 13 of the LoViT framework; this illustrates the steps completed by the computer system to achieve the processing of surgical video to detect and label surgical phases and phase transitions. Upon start s130 of the LoViT architecture in the computer system, the computer system will look to train the LoViT framework s131 with the associated training data i.e., the surgical video such as Cholec80 or AutoLaparo. This training step will ensure that the LoViT system is primed for live or offline surgical video and will ensure high levels of robustness and accuracy when detecting surgical phases and phase transitions within the surgical video. In s132 the LoViT system will receive the surgical video, whether that is via a live feed from the current surgery or from offline surgical video that has been previously recorded and stored. In s133 the LoViT system begins the process of analysing the received surgical video. The first step in achieving this is to extract the local, fine-grain information from the surgical video—this is achieved by passing the surgical video through temporally-rich spatial feature extraction. In s134 the plurality of local information and fine-grain information extracted from the surgical video via the temporally-rich spatial feature extraction is aggregated together using the local temporal feature program. Next, in s135 global relationships or less fine-grain information is extracted from the surgical video using the global temporal feature program. In s136 the extracted global relationships or information is fused or combined with the local or fine-grain information extracted at s133 and s134. This fusion is completed by the multi-scale temporal fusion model. In s137, the fused local and global information is fed into the heatmap-based guided supervision or the Gaussian heatmap kernel. In s138, the LoViT will be able to recognise the surgical phases and phase transitions within the received surgical video and label them accordingly. S139 signals the completion of the detection and labelling of the surgical phases in the surgical video.

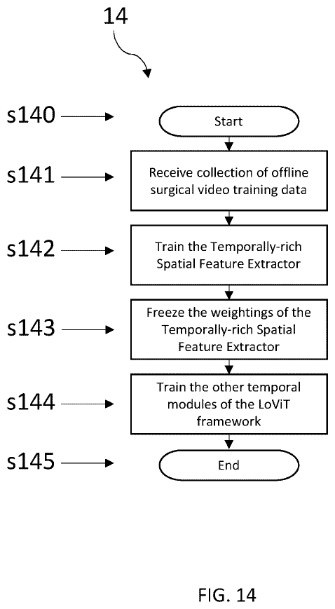

FIG. 14 shows a flow diagram of the training process 140 of the LoVit framework; this illustrates the steps completed by the computer system to achieve the training of the LoViT framework to ensure an accurate and robust response to live and offline surgical video. Upon start of the training process, the system will process with s141 which is to collate and receive a plurality of offline surgical video to be used as training data. In this example, the LoViT architecture was trained using the Cholec80 and AutoLaparo dataset, however, any other surgical dataset with labelled phases and phase transitions can be used to train the LoViT architecture. In s142 the temporally-rich spatial feature extractor is trained first using the associated surgical training data that was collated in s141. S142 is a repetitive process where the temporally-rich spatial feature will be trained repeatedly until it reaches an appropriate level of accuracy and robustness. Once this level of training has occurred, in s143 the weightings of the temporally-rich spatial feature extractor will be frozen to ensure that is does not change from it's trained state. Next, in s145 the other temporal modules of the LoViT framework are trained in turn; this includes the local temporal feature aggregator, the global temporal feature aggregator and the multi-scale temporal feature fusion head. Once, all the temporal modules have been trained to the necessary level the training process will end at s145.

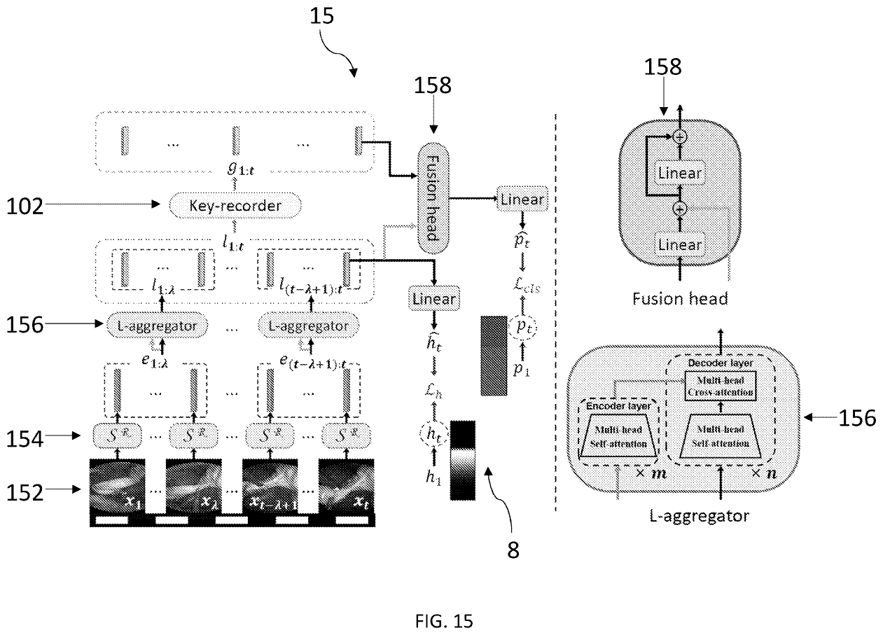

FIG. 15 illustrates our proposed SKiT (fast key information video transformer) architecture. Our model takes a video stream Xₜ={xᵢ}ₗ₌₁^{t} as input to recognise the surgical phase \hat{p}ₜ of the current frame xₜ in an online manner, where xᵢ is the i-th video frame contained in Xₜ. We propose an architecture with a Key-recorder that captures global information by recording key events, thereby eliminating the need for costly aggregation operations. This approach addresses the computational limitations that result from large-sized local feature aggregator and global feature aggregator operations inherent in LoViT, which begins with extracting spatial features, followed by the extraction of small and large-sized local temporal features, and then aggregates global long sequence features using a global temporal feature aggregator while performing multi-scale fusion with local features. We describe our proposed architecture in the following sections.

Surgical videos can last for up to a few hours and exhibit strong dependence among different phases. Therefore, it is essential for a recognition model to have the ability to process long video inputs. However, training such a model in an end-to-end manner is challenging. Systems are often implemented by first training a spatial feature extractor and then freeze its weights before training the rest of the temporal modules. However, learning phases from a single image frame can be challenging since the feature extractor model may have similar image frames appearing at different phases as inputs, and phase recognition depends not only on the current frame but also on previous frames. To address these problems, we use the method proposed in LoVIT to train a temporally-rich spatial feature model S^{R}. We input a sequence of 30 image frames Xₜ′⊆Xₜ={xᵢ}ᵢ₌₁^{t} where xᵢ is the i-th frame of online video stream xₜ, and t is the current frame index. Xₜ′ consists of image frames sampled at equal intervals from the beginning of the current phase up to the current frame, and is used to build a more robust phase recognition compared to that one that uses only one single image frame. We first use S^{R} to embed all frames of Xₜ′ into spatial features independently, followed up by a Transformer that aggregates them to predict the phase pit of the current image frame xₜ. The temporally-rich supervision method S^{R} can be more well-trained and could extract spatial features more accurately. Note that, for each xᵢ we define the extracted spatial feature by S^{R} as eᵢ, and we freeze the weight of S^{R} while training the temporal module of SKiT during the second stage.

The spatial features extracted by S^{R} are used by a Transformer-based local temporal feature aggregator L-aggregator that captures the current fine-grained temporal information, such as actions, moving tools, and operated organs. L-aggregator is defined as follows:

$$( {l}_{t - λ + 1} , … , {l}_{t} ) = L - aggregator ( {e}_{t - λ + 1} , … , {e}_{t} ) .$$

Here, eₜ is the current spatial feature extracted by S^{R}, lₜ represents the current local temporal feature of the t-th frame, and A is the input window size of the L-aggregator.

We implement L-aggregator using a Transformer-based module as shown in FIG. 15. It consists of an m-layer self-attention encoder that receives one branch input and an n-layer cascaded self-attention and cross-attention decoder that receives the second branch input and fuses it with the encoder's output. We then duplicate the current A-length spatial feature sequence (e_{t-λ+1}, . . . , eₜ) into two branches and input them into the decoder and encoder, respectively.

Global key information and its long-term dependencies across surgical phases are crucial for surgical phase recognition. While previous methods have proposed the integration of global features using complex temporal models, inference time increases with input sequence length, even when using efficient self-attention mechanisms such as ProbSparse, which is used by LoViT. Moreover, these complex temporal models are easy to over-fit and result in remembering confusing information. To address these issues, we propose Key-recorder, which uses key pooling to only record the limited appeared key information, and discard confusing information.

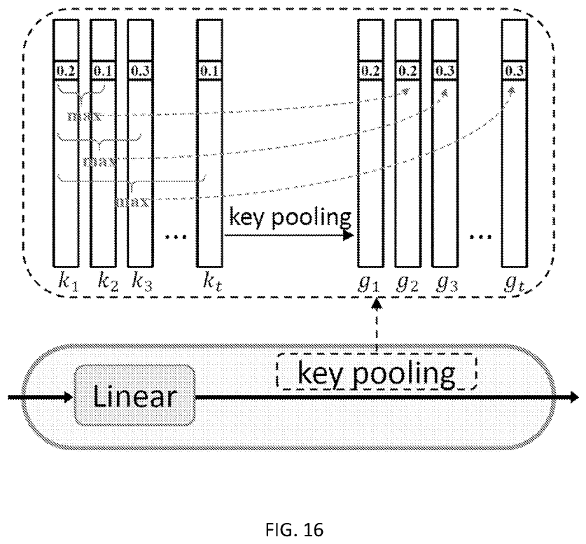

As shown in FIG. 16, given a local temporal feature sequence Lₜ=(l₁, l₂, . . . , lₜ) we first use a linear layer to embed them into a low-dimensional key feature sequence Kₜ={kᵢ}ᵢ₌₁^{t}, where kᵢ∈ [symbol] ^{d}^{ₖ} is the i-th feature vector of Kₜ containing dₖ key information. The j-th value of kₜ represents the response level of the i-th frame local feature to the j-th key information. In other words, it represents the possibility that the i-th frame contains the j-th key information, where the key information could be the result of a feature with actual physical meaning, such as tool, organ, and action, or other abstract meaning, which is learned by the model. Key pooling then aims to determine if the j-th key information appears in the global sequence up to the i-th frame. Specifically, Key pooling uses an element-wise max operation to record the maximum value of the i-th position in feature vectors from the beginning of the feature sequence up to the j-th feature vector as the value

$${g}_{i}^{j} :$$

$${g}_{i}^{j} = \{ \begin{matrix}max ( {g}_{i - 1}^{j} , {k}_{i}^{j} ) , & if i > 1 \\ {k}_{i}^{j} , & otherwise\end{matrix}$$

During test inference, Key-recorder only needs to compare two feature vectors gₜ₋₁ and kₜ to recall the appeared global key information gₜ needed for recognizing the current t-th frame, with time complexity of 0(1). As a result, the time consumption of the Key-recorder is negligible and independent of the length of the surgical video.

The phase of the current frame is then determined by the current local information and the previous global information. Specifically, we adopt a small fusion head that combines the global appeared key feature gₜ with the current local feature lₜ. As shown in FIG. 15, we first adopt a linear layer to encode the key feature gₜ to the same dimension as Iₜ before adding them together. The second linear layer takes as input this combination following a residual layer to optimize the output.

In order to give importance to the key information existing during the time where phase transitions occur, we reuse the phase transition-aware supervision mechanism proposed in LoViT. It consists of phase transition points projected onto a one-dimensional left-right asymmetric Gaussian kernel heatmap, called phase transition

$$map H = {\{ {h}_{i} \}}_{i = 1}^{T} ,$$

where hᵢ is the i-th phase transition map value of T-frame video, expressed as:

$${h}_{i} = \{ \begin{matrix}exp ( - \frac{{( i - {b}_{Pi} )}^{2}}{2 {σ}_{r}^{2}} ) , & {b}_{Pi} - 3 {σ}_{l} < i < {b}_{Pi} \\ exp ( - \frac{{( i - {b}_{Pi} )}^{2}}{2 {σ}_{r}^{2}} ) , & {b}_{Pi} < i < {b}_{Pi} + 3 {σ}_{r} \\ 0 , & otherwise\end{matrix}$$

where bₚᵢ is the index of the frame where the current phase pₜ starts, and 3σₗ and 3σᵣ_{^{r}} are the left- and right-side kernel length departing from bₚᵢ respectively. Consequently, our loss function is a weighted sum of the phase transition map loss and phase classification loss:

$$ℒ = {ℒ}_{1} ( \hat{h} , h ) + {ℒ}_{CE} ( \hat{p} , p )$$

Here [symbol] ₁ (ĥ, h) denotes the [symbol] ₁ loss between the predicted heatmap ĥ and its ground truth h, whereas [symbol] _{CE} (\hat{p},p) represents the cross-entropy loss between the predicted phase p and its ground truth p.

### Experimental Results of SKIT

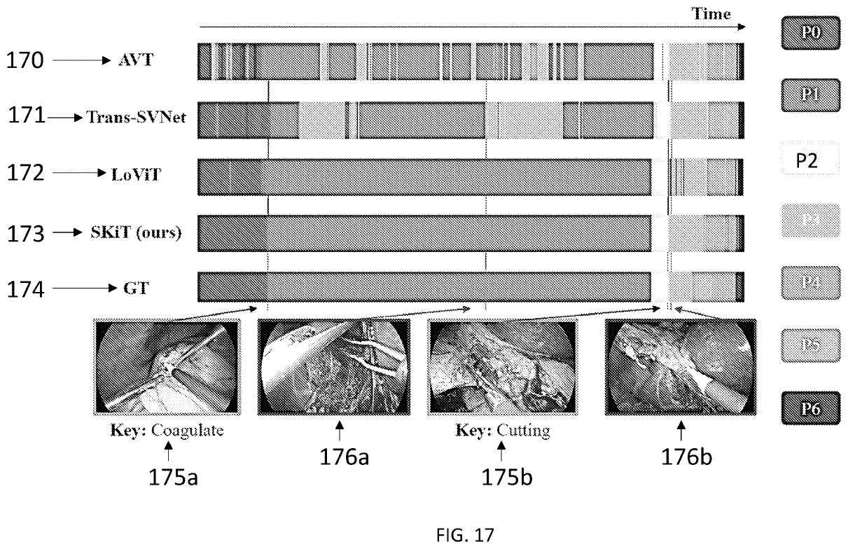

We conducted a comparative study of SKiT with other state-of-the-art methods for surgical phase recognition and action anticipation on Cholec80 and AutoLaparo datasets. Table 5 shows the quantitative results. SKiT outperformed the previous state-of-the-art method, LoVIT, with an improvement in accuracy of 0.94 pp (percentage points) on Cholec80 (from 91.50% to 92.46%) and 1.50 pp on AutoLaparo (from 81.43% to 82.93%), while maintaining a simpler and more efficient framework. Moreover, SKiT exhibited superior phase-level metrics such as precision, recall, and Jaccard, which address the issue of phase imbalance effects. SKiT also achieved lower standard deviations of accuracy across different videos, with a reduction of 1.0 pp and 0.6 pp on Cholec80 and AutoLaparo datasets, respectively, compared to LoViT. This indicates that SKiT achieved more stable performance across various surgical videos. We present representative visual results for phase recognition on Cholec80 and AutoLaparo datasets in FIG. 17. Overall, SKIT outperformed other methods in most places where “key feature” (as shown in frames highlighted in green) was recognized by our model as key information to correctly classify the phase, while being robust to confusing image frames.

TABLE 5
The results (%) of different state-of-the-art methods
on both the Cholec80 and AutoLaparo datasets.

| Dataset | Methods | Accuracy | Precision | Recall | Jaccard |
|---|---|---|---|---|---|
| Cholec80 | EndoNet* | 81.7 ± 4.2 | 73.7 ± 16.1 | 79.6 ± 7.9 | — |
| | MTRCNet-CL* | 89.2 ± 7.6 | 86.9 ± 4.3 | 88.0 ± 6.9 | — |
| | PhaseNet | 78.8 ± 4.7 | 71.3 ± 15.6 | 76.6 ± 16.6 | — |
| | SV-RCNet | 85.3 ± 7.3 | 80.7 ± 7.0 | 83.5 ± 7.5 | — |
| | OHFM | 87.3 ± 5.7 | — | — | 67.0 |
| | TeCNO | 88.56 | 81.64 | 85.24 | — |
| | Trans-SVNet | 89.11 ± 7.03 | 84.72 | 83.63 | 72.50 |
| | AVT | 86.73 ± 7.62 | 77.34 | 82.13 | 66.42 |
| | LoViT | 91.50 ± 6.10 | 83.07 | 86.5 | 74.15 |
| | SKiT | 92.46 ± 5.10 | 84.59 | 88.52 | 76.74 |
| AutoLaparo | SV-RCNet | 75.62 | 64.02 | 59.70 | 47.15 |
| | TMRNet | 78.20 | 66.02 | 61.47 | 49.59 |
| | TeCNO | 77.27 | 66.92 | 64.60 | 50.67 |
| | Trans-SVNet | 78.29 | 64.21 | 62.11 | 50.65 |
| | AVT | 77.81 ± 9.38 | 68.04 | 62.23 | 50.66 |
| | LoViT | 81.43 ± 7.35 | 85.07 | 65.85 | 55.90 |
| | SKiT | 82.93 ± 6.75 | 81.78 | 70.12 | 59.86 |

We study the inference time of SKiT in contrast with the previous version of LoViT using different numbers of input frames It should be noted that the measured values may be slower than the actual values due to testing on a GPU cluster and sharing the CPU with other tasks, which leads to unstable inference times. To compare the temporal module inference time, we excluded the spatial feature extractor inference time, which takes about 9 ms per frame of inference time. Our results show that SKiT is eight times faster than LoVIT, with an online inference time of approximately 7 ms per frame (142 fps) versus 55 ms per frame (18 fps) for the reported 3000 frames input in LoViT. Notably, the speed advantage of SKiT increases as the input length becomes longer. Additionally, the inference time of SKiT is not dependent on the input length required to capture the entire video-length receptive field, making it highly suitable for constructing a stable and efficient surgical recognition system. Although Trans-SVNet achieved a high-speed inference time of 10 ms per frame (91 fps), its perceptive field is fixed after design due to the TCN structure, which means it cannot maintain the whole-video receptive field when processing videos of variable lengths. TMRNet has the ability to process variable-length videos while maintaining a global receptive field with the non-local structure, but its inference time increases with the length of the video, and its average inference speed is slow, at 80 ms per frame (11 fps).

We investigated the impact of our proposed Key-recorder for recording globally appeared key information. Table 6 presents the results, where ‘V’ represents the local temporal feature extracted by the L-aggregator, ‘g^{s}’ denotes the global key feature recorded from spatial feature e, and ‘gT’ stands for the key feature recorded from local temporal feature I. By adding the global key feature recorded from the local temporal feature, we achieved improvements in recognition performance on both datasets across all metrics. For example, on the Cholec80 dataset, we observed an accuracy improvement of 3.13 pp (from 89.33% to 92.46%), while on the AutoLaparo dataset, we observed an accuracy improvement of 0.96 pp (from 81.97% to 82.93%). This highlights the significance of capturing global appeared key information for recognizing the current phase. Moreover, we observed that the improvement on Cholec80 was higher than AutoLaparo, which suggests stronger global dependencies for Cholec80. We observed that the workflow of the AutoLaparo dataset is more complex and the dependencies among phases are weaker. However, we observed that if the global feature is solely recorded from the spatial feature e, the resulting recorded key feature g^{s} may have a negative impact on phase recognition. This is because the spatial feature alone may not accurately capture the status of every frame, including some ambiguous frames, leading to noise in the recorded key feature. This noise negatively affects the overall quality of the recorded key information since it is considered in the maximum operation of our key pooling mechanism. To address this issue, we incorporated local window size frames to more accurately describe the features of each frame and reduce the negative impact of noise.

TABLE 6
The results (%) of different combinations of features
on both the Cholec80 and the AutoLaparo datasets.

| Dataset | Feature | Accuracy | Precision | Recall | Jaccard |
|---|---|---|---|---|---|
| Cholec80 | l | 89.33 ± 7.28 | 81.05 | 85.05 | 71.07 |
| | l + g^{s} | 88.14 ± 7.08 | 77.80 | 80.78 | 65.90 |
| | l + g^{T} | 92.46 ± 5.10 | 84.59 | 88.52 | 76.74 |
| AutoLaparo | l | 81.97 ± 7.42 | 79.61 | 69.05 | 58.93 |
| | l + g^{s} | 81.04 ± 7.34 | 83.11 | 67.79 | 57.20 |
| | l + g^{T} | 82.93 ± 6.75 | 81.78 | 70.12 | 59.86 |

We also examined the impact of the length parameter d_{g} on the recognition performance of Key-recorder. The length of the key feature d_{g} determines the amount of key information that Key-recorder can store. As shown in Table 7, the model's performance is affected by this length parameter, highlighting the importance of storing an appropriate amount of key information to improve recognition performance. Insufficient key information can lead to inadequate learning, while excessive information can result in redundancy and overfitting. Therefore, it is crucial to strike a balance between the amount of key information and the risk of overfitting. In other words, Key-recorder should store a limited number of key events that are likely to occur in the video to efficiently capture the necessary information.

TABLE 7
The results (%) of different key feature lengths, dk, with
SKiT on both the Cholec80 and the AutoLaparo datasets.

| Dataset | dₖ | Accuracy | Precision | Recall | Jaccard |
|---|---|---|---|---|---|
| Cholec80 | 8 | 90.61 ± 6.38 | 82.89 | 86.21 | 73.56 |
| | 16 | 90.61 ± 6.82 | 83.30 | 86.28 | 73.97 |
| | 32 | 92.14 ± 5.42 | 85.11 | 86.60 | 75.68 |
| | 64 | 92.46 ± 5.10 | 84.59 | 88.52 | 76.74 |
| | 128 | 92.05 ± 5.56 | 83.79 | 88.07 | 75.67 |
| AutoLaparo | 8 | 82.56 ± 6.92 | 79.62 | 70.12 | 60.46 |
| | 16 | 80.94 ± 8.42 | 73.02 | 64.65 | 55.00 |
| | 32 | 82.93 ± 6.75 | 81.78 | 70.12 | 59.86 |
| | 64 | 81.85 ± 6.89 | 82.71 | 68.90 | 58.43 |
| | 128 | 81.49 ± 8.22 | 70.29 | 66.07 | 55.45 |

As previously discussed, FIG. 15 shows a further possible architecture of the second embodiment of the present invention, relating to the SKiT system 15. As can be seen, there are many likenesses to the previous possible architecture of the second embodiment SKiT system 10 and the original LoViT system 2. For example, this architecture contains the same recorder 102 as in the SKiT system 10 and the same heat-map guided supervision 8. The architecture of the Fusion head 158 and the Local aggregator, L-aggregator 156, can be seen in FIG. 15. First, a spatial feature extractor S^{R} 154 is used to independently extract a sequence of spatial features (eᵢ, . . . , eₜ) from a t-frames video stream (xᵢ, . . . , xₜ). A Transformer-based local temporal aggregator (L-aggregator) 156 with a window size of A generates the local fine-grained temporal feature sequence (l₁, . . . , lₜ) . . . . The Key-recorder 102 is then used to record global appeared key information, where gₜ represents the recorded key information from the beginning to the t-th frame. Last, a Fusion head is adopted to fuse lₜ and gₜ to predict the phase pit while a linear layer uses lₜ to predict the current phase transition map value ĥₜ. Note that we only need to run S^{R} and L-aggregator once during inference. In the fusion head 158, a linear layer first embeds the first branch input into the same length as the second branch, followed by element-wise addition, and a residual layer that is tailed to output final fusion. The L-aggregator 156 contains an m-layer self-attention for encoding the first branch, and an n-layer cascaded self-attention and cross-attention decoder. Further, the transformer-based local temporal feature extractors may comprise embedded previously processed frames such that that current frames of the surgical video can be compared with previously processed frames of the surgical video.

FIG. 16 shows the architecture of the key-recorder module 102. The key-recorder module comprises a linear layer which embeds inputs into low-dimensional key features, followed by our key pooling operation to record the appeared key information for every current frame. We illustrate the working principle of the key pooling with a t-length key feature sequence (kᵢ, . . . , kₜ), whereby for each element position, we take the maximum value from the beginning of the sequence up to the current element along the sequence direction (see dashed arrows) to get a global feature sequence (gᵢ, . . . , gₜ).

FIG. 17 shows qualitative comparisons with other methods on selected frames from Cholec80 datasets. We show multiple methods' results on a given video with its ground truth (GT). Our method is able to correctly recognise key transition frames and ignore ambiguous frames, whereas previous methods fail in those specific misleading cases. The comparisons are shown via the various rows associated with the training images from the Cholec80 dataset. For example, the AVT performance is shown in row 170, the Trans-SVNet performance is shown in row 171 and the first embodiment of the present invention, LoViT is shown in row 172. Row 173 depicts the current SKiT corresponding to the further embodiment of the present disclosure. Row 174 shows the Ground Truth, GT_{P}. The key for the different phases, P1-P6, that appear in the Cholec80 dataset can be seen on the far-right hand side of FIG. 17. Images 175a-b and 176a-b are associated surgical phase images from the Cholec80 at specific intervals of time. Images 175a and 175b show key transition frames within the Cholec80 dataset. Images 176a and 176b show ambiguous frames that should be ignored. It can be seen in row 173, relating to the SKiT system, that the system is capable of detecting the key transition frames and ignoring the ambiguous frames. The SKiT system also out performs all other models or systems.

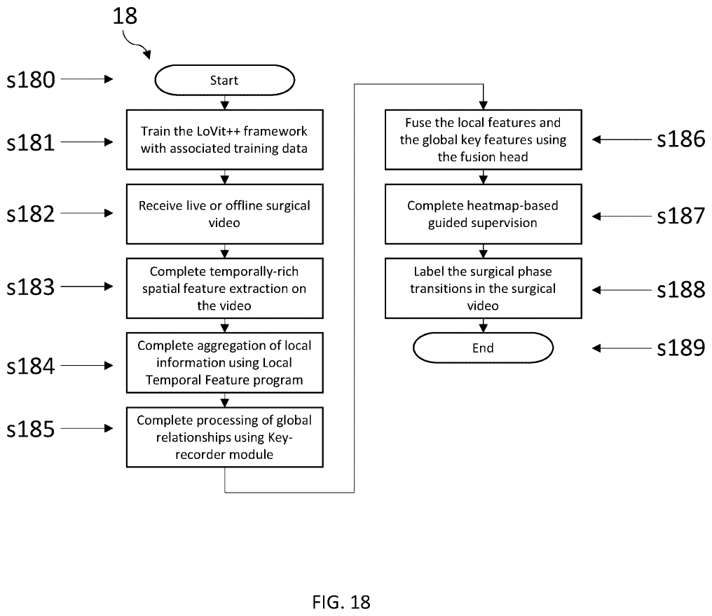

FIG. 18 shows a flow diagram for the operation 18 of the SKiT framework; this illustrates the steps completed by the computer system to achieve the processing of surgical video to detect and label surgical phases and phase transitions. Upon start s180 of the SKIT architecture in the computer system, the computer system will look to train the SKIT framework s181 with the associated training data i.e., the surgical video such as Cholec80 or AutoLaparo. This training step will ensure that the SKiT system is primed for live or offline surgical video and will ensure high levels of robustness and accuracy when detecting surgical phases and phase transitions within the surgical video. In s182 the SKiT system will receive the surgical video, whether that is via a live feed from the current surgery or from offline surgical video that has been previously recorded and stored. In s183 the SKIT system begins the process of analysing the received surgical video. The first step in achieving this is to extract the local, fine-grain information from the surgical video—this is achieved by passing the surgical video through temporally-rich spatial feature extraction or in other words, performing local temporal feature extraction on the spatial features of the subset of frames of the surgical video to identify a sequence of frames that include local temporal information indicative of a surgical phase. The local temporal information may be indicative of surgical actions, surgical tools, surgeon hands, operated organs etc. In s184 the plurality of local information and fine-grain information extracted from the surgical video via the temporally-rich spatial feature extraction or the local temporal feature extraction is aggregated together using the local temporal feature program. Next, in s185 the key global features are extracted using the key-recorder module or in other words, by performing global key information extraction on the sequence of frames that include local temporal information indicative of a surgical phase to identify whether global key information indicative of a surgical phase appears in a global sequence of frames. In s186 the extracted global key features are fused or combined with the local or fine-grain information extracted at s183 and s184 in order to form overall surgical phase information comprising one or more temporal points of interest in the surgical video sequence that are indicative of surgical phase transition points. It is worth noting that the global key information and the local temporal information such that the dimensions of the global key information and the dimensions of the local temporal information match prior to combining. This fusion is completed by the fusion head. In s187, the fused local and global key features are fed into the heatmap-based guided supervision or the Gaussian heatmap kernel. In s188, the SKiT will be able to recognise the surgical phases and phase transitions within the received surgical video and label them accordingly. S189 signals the completion of the detection and labelling of the surgical phases in the surgical video. It is further worth noting that the global key recorder applies a probability rating to each frame of the sequence of frames that include local temporal information, the probability rating being indicative of the likelihood the frame contains a global key information.

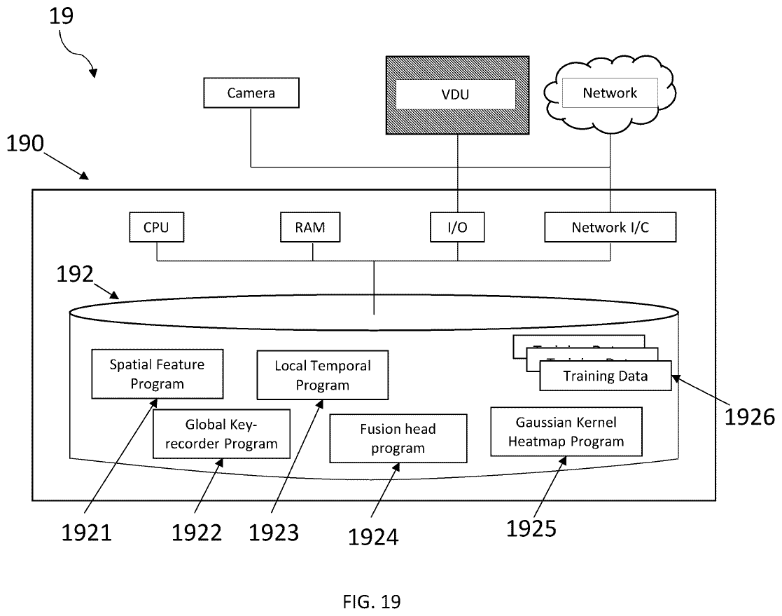

FIG. 19 is a block diagram of a typical general purpose computer system 19 that can form the processing platform for the SKiT surgical video phase detection and labelling, as described, according to a further embodiment of the present invention. The computer system 19 comprises a central processing unit (CPU), random access memory (RAM), and input/output ports (I/O) into which data can be received and output therefrom as is well known in the art. Additionally included is a camera unit which may be positioned to record live surgical video, a visual display unit and a network access point for sending or receiving data including the receiving of prerecorded surgical video. Although, many further appliances could be used if necessary.

The computer system 19 also includes some non-volatile storage 192, such as a hard disk drive, solid-state drive, or NVMe drive. Stored on the non-volatile storage 192 is a number of executable computer programs together with data and data structures required for their operation or training. Overall control of the system 19 is undertaken through the execution of the Spatial Feature program 1921, the Global Key-recorder program 1922, the Local Temporal Program 1923, the fusion head program 1924 and the Gaussian Kernel Heatmap program or heatmap-based supervision program 1925. The other data contained in the non-volatile storage 192 is the surgical video training data 1926 which could be include, but is not limited to, the Cholec80 or AutoLaparo datasets.

It will be understood that the above list is non-exhaustive, and that the video labelling method and system described herein is applicable to many technical problem domains to which machine learning models may be applied.

Various modifications, whether by addition, substitution, or deletion will be apparent to the intended reader to provide further embodiments of the present disclosure, any and all of which are intended to be encompassed by the appended claims.

### REFERENCES

[1] X. Wang, S. Sun, L. Xie and L. Ma, “Efficient Conformer with Prob-Sparse Attention Mechanism for End-to-End Speech Recognition”, Audio, Speech and Language Processing Group, School of Computer Science, Northwestern Polytechnical University, Xi'an, China.
[2] A. P. Twinanda, S. Shehata, D. Mutter, J. Marescaux, M. de Mathelin, and N. Padoy, “Endonet: A deep architecture for recognition tasks on laparoscopic videos,” IEEE Trans. Medical Imaging, vol. 36, no. 1, pp. 86 97, 2017.
[3] Z. Wang, B. Lu, Y. Long, F. Zhong, T.-H. Cheung, Q. Dou, and Y. Liu, “Autolaparo: A new dataset of integrated multi-tasks for image-guided surgical automation in laparoscopic hysterectomy,” in Medical Image Computing and Computer Assisted Intervention—MICCAI 2022.
[4] H. Law, and J. Deng. “CornerNet: Detecting Objects as Paired Keypoints” in International Journal of Computer Vision 128:642-656 (2020).

1. A computer-implemented method of surgical video phase labelling of a surgical video, wherein the surgical video comprises a plurality of frames each defining a temporal point in a surgical video sequence, the computer-implemented method comprising:
sampling a subset of frames from the plurality of frames of the surgical video;
extracting spatial features from the subset of frames;
performing local temporal feature extraction on the spatial features of the subset of frames of the surgical video to identify a sequence of frames that include local temporal information indicative of a surgical phase;
performing global key information extraction on the sequence of frames that include the local temporal information indicative of the surgical phase to identify whether global key information indicative of the surgical phase appears in a global sequence of frames; and
combining the global key information and the local temporal information to form overall surgical phase information comprising one or more temporal points of interest in the surgical video sequence that are indicative of surgical phase transition points.

2. The computer-implemented method of claim 1, the computer-implemented method further comprising:
projecting the overall surgical phase information that is indicative of one or more surgical phase transition points onto a heatmap;
confirming that the heatmap shows that the overall surgical phase information is indicative of a surgical phase transition; and
labelling the surgical phase in the surgical video if the overall surgical phase information indicated the surgical phase transition had occurred as confirmed by the heatmap.

3. (canceled)

4. The computer-implemented method of claim 1, further comprising:
using a one-dimensional Gaussian Kernel during training as guided supervision to improve extraction of the local temporal information and the global key information and improving combination of the local temporal information and the global key information; and
dropping the one-dimensional Gaussian Kernel during inference to assign a surgical phase label based on the local temporal information, the global key information, and the combination of the local temporal information and the global key information.

5. The computer-implemented method of claim 1,
wherein the surgical video is a live stream from an active surgery and the subset of frames of the surgical video contains past and present frames of the surgical video, or
wherein the surgical video is a prerecorded video of a surgery and the subset of frames of the surgical video contains past, present and future frames of the surgical video.

6. The computer-implemented method of claim 4,
wherein the one-dimensional Gaussian Kernel is asymmetric, and the one-dimensional Gaussian Kernel provides a higher weighting factor to past and present frames of the surgical video in comparison to future frames of the surgical video, or
wherein the one-dimensional Gaussian Kernel is symmetric, and the one-dimensional Gaussian Kernel provides an equal weighting factor to past, present and future frames of the surgical video.

7-8. (canceled)

9. The computer-implemented method of claim 1, wherein the local temporal feature extraction is performed by a transformer-based local temporal feature extractor to process sequence inputs and process local information.

10. The computer-implemented method of claim 9, wherein the transformer-based local temporal feature extractor comprises embedded previously processed frames, and the computer-implemented method further comprises:
comparing a current frame of the surgical video with the embedded previously processed frames of the surgical video.

11. The computer-implemented method of claim 1, wherein the global key information extraction is performed by a global key recorder utilizing max-pooling to process one or more relationships of surgical phases spanning across at least one hour of time in the surgical video.

12. The computer system of claim 19, wherein combining of the local temporal information and the global key information is performed by a fusion head which comprises a transformer-based multi-scale fusion module.

13. The computer system of claim 19, the actions further comprising:
encoding the global key information and the local temporal information such that first dimensions of the global key information and second dimensions of the local temporal information match prior to combining.

14. (canceled)

15. The computer system of claim 19, wherein the local temporal information is indicative of one or more of actions, surgical tools, surgeon hands, or operated organs.

16. The computer system of claim 19, wherein the local temporal feature extraction is performed by a local temporal feature aggregator.

17-18. (canceled)

19. A computer system for implementing a surgical video labelling algorithm, the computer system comprising:
one or more processor units; and
a computer readable storage medium storing one or more computer programs such that when performed by the one or more processor units cause the computer system to carry out actions, comprising:
sampling a subset of frames from a plurality of frames of a surgical video,
wherein each of the plurality of frames defines a temporal point in a surgical video sequence,
extracting spatial features from the subset of frames;
performing local temporal feature extraction on the spatial features of the subset of frames of the surgical video to identify a sequence of frames that include local temporal information indicative of a surgical phase;
performing global key information extraction on the sequence of frames that include the local temporal information indicative of the surgical phase to identify whether global key information indicative of the surgical phase appears in a global sequence of frames; and
combining the global key information and the local temporal information to form overall surgical phase information comprising one or more temporal points of interest in the surgical video sequence that are indicative of surgical phase transition points.

20. A computer-implemented method of surgical video phase labelling, wherein a surgical video comprises a plurality of frames each defining a temporal point in a surgical video sequence, the computer-implemented method comprising:
sampling a subset of frames from the plurality of frames of the surgical video;
extracting spatial features from the subset of frames;
performing local temporal feature extraction on the spatial features of the subset of frames of the surgical video on a first temporal scale to identify local temporal information over the first temporal scale indicative of a surgical phase;
performing global temporal feature extraction on the spatial features of the subset of frames of the surgical video on a second temporal scale longer than the first temporal scale to identify global temporal information over the second temporal scale indicative of the surgical phase; and
fusing the local temporal information and the global temporal information together to form overall surgical phase information comprising one or more temporal points of interest in the surgical video sequence that are indicative of surgical phase transition points.

21. (canceled)

22. The computer-implemented method of claim 20, further comprising:
projecting the overall surgical phase information that is indicative of one or more surgical phase transition points onto a heatmap,
wherein the heatmap is produced using a one-dimensional Gaussian Kernel by using ground truth labels of surgical phase transitions.

23-27. (canceled)

28. The computer-implemented method of claim 20, wherein the local temporal feature extraction is performed by a plurality of transformer-based local temporal feature extractors to process sequence inputs and process local information.

29-30. (canceled)

31. The computer-implemented method of claim 28, wherein the plurality of transformer-based local temporal feature extractors is positioned in a cascaded arrangement.

32. The computer-implemented method of claim 20, wherein the global temporal feature extraction is performed by a global temporal informer to process one or more relationships of surgical phases spanning across at least one hour of time in the surgical video.

33. The computer-implemented method of claim 20, wherein fusing of the local temporal information and the global temporal information is performed by one or more transformer-based multi-scale fusion module, and the computer-implemented method further comprises:
fusing different granularities of the local temporal information using a first transformer-based multi-scale fusion module to form complete local temporal information; and
fusing the complete local temporal information with the global temporal information using a second transformer-based multi-scale fusion module.

34. (canceled)

35. The computer-implemented method of claim 20,
wherein performing the local temporal feature extraction identifies persistent local temporal information indicative of the surgical phase across the first temporal scale,
wherein performing the global temporal feature extraction identifies persistent global temporal information indicative of the surgical phase across the second temporal scale.

36-45. (canceled)
